(19) United States
(12) Patent Application Publication
(10) Pub. No.: US 2024/0171957 A1
(43) Pub. Date: May 23, 2024

(54) Location-Based Services and Wireless Emergency Alert for Neutral Host With MNOS Aligned to Use the Same TAC-ID and Cell-ID and MNO Obtains a Semi-Independent PLMN-ID for Enterprise Neutral Host

(71) Applicant: Celona, Inc., Campbell, CA (US)

(72) Inventor: Srinivasan Balasubramanian, San Diego, CA (US)

(21) Appl. No.: 18/513,428

(22) Filed: Nov. 17, 2023

Related U.S. Application Data
(63) Continuation-in-part of application No. 18/506,609, filed on Nov. 10, 2023.
Application No. 18/506,609 is a continuation-in-part of application No. 17/822,098, filed on Aug. 24, 2022.
(60) Provisional application No. 63/426,315, filed on Nov. 17, 2022.
(60) Provisional application No. 63/424,257, filed on Nov. 10, 2022.
(60) Provisional application No. 63/426,315, filed on Nov. 17, 2022.
(60) Provisional application No. 63/238,001, filed on Aug. 27, 2021.
(60) Provisional application No. 63/241,164, filed on Sep. 7, 2021.

(51) Int. Cl. H04W 4/90; H04W 4/029

(52) U.S. Cl. CPC H04W 4/90; H04W 4/029

(57) ABSTRACT

A system and method are provided for sending alert messages to end users. Based on a location component, one or more particular UEs (User Equipment) that communicate via a private network are determined. Directing an emergency message to a subset of Access Points (APs) within a private network based on the one or more particular UEs determined. In some embodiments, an Identifier Mapping Database (IMD) maps the Mobile Network Operator (MNO) identifiers to Private CBRS/Non-Public Network (PCNN) identifiers. In some embodiments, a roaming connection is established between the private network and the MNO network. In some embodiments, a UE cell ID is mapped to an AP based on a notification area.

### CROSS-REFERENCE TO RELATED APPLICATIONS—CLAIM OF PRIORITY

The present application claims priority to U.S. Provisional Application No. 63/426,315, filed Nov. 17, 2022, entitled “CBRS RAN Sharing for Neutral Hosting” which is herein incorporated by reference in its entirety. This application is also a continuation-in-part, and claims priority to, U.S. Non-Provisional application Ser. No. 18/506,609, filed Nov. 10, 2023, entitled “Location-Based Services and Wireless Emergency Alert for Neutral Host with System Information Block Broadcasts Based on Private Network Tracking Area Code ID ad Cell ID”, which application claims priority to U.S. Provisional Application No. 63/424,257, filed Nov. 10, 2022, entitled “Location Based Services and Wireless Emergency Alert for Neutral Host with System Information Block Broadcasts Based on Private Network Tracking Area Code ID and Cell ID”, and to U.S. Provisional Application No. 63/426,315, filed Nov. 17, 2022, entitled “CBRS RAN Sharing for Neutral Hosting”, which are all herein incorporated by reference in their entirety. Application Ser. No. 18/506,609 is a continuation-in-part, and claims priority to, U.S. Non-Provisional application Ser. No. 17/822,098, filed Aug. 24, 2022, entitled “Location Based Services and Wireless Emergency Alert for Neutral Host”, which application claims priority to U.S. Provisional Application No. 63/238,001, filed Aug. 27, 2021, entitled “Location Based Services and Wireless Emergency Alert for Neutral Host”, and to U.S. Provisional Application No. 63/241,164, filed Sep. 7, 2021, entitled “Location Based Services and Wireless Emergency Alert for Neutral Host”, which are all herein incorporated by reference in their entirety.

### BACKGROUND

### (1) Technical Field

The disclosed method and apparatus relate generally to systems for managing and directing a transmission of public warning system (PWS) message. In particular, the disclosed method and apparatus relate to directing one and only one PWS message to components of a neutral host.

### (2) Background

The current 3rd Generation Partnership Project (3GPP) and Global System for Mobile Communications Association (GSMA) standards forums are typically directed to writing specifications for subscription management for large Mobile Network Operators (MNOs) that typically have nationwide coverage hosting a large number of users. Two particular technical specifications written by 3GPP are (1) 3GPP TS 22.168 Earthquake and Tsunami Warning System (ETWS) requirements; Stage 1 and (2) 3GPP TS 22.268 Public Warning System (PWS) requirements. These specifications provide technical information regarding how PWS messages and other warnings are transmitted to users of the communications systems relevant to 3GPP. However, since these specifications are directed primarily to the MNOs, issues arise that are not addressed in the 3GPP technical specification when it is desirable to direct warnings to UEs (User Equipment) connected through a private/non-public communications network. For example, issues arise when a private campus in which a CBRS (Citizens Broadband Radio System) defined by CBRS Alliance Network Services Technical Specification_CBRSA-TR-1001 is deployed and through which the UEs receive communications. In some embodiments, a MOCN (Multi-Operator Core Network) gateway serves as a single point through which communications from a UE are directed to one of several different network cores. The method and apparatus disclosed in this document allow PWS messages to be transmitted to UEs that are communicating through a neutral host system or other private network and also allows UEs to send information to locate the UE when the UE makes an E-911 call.

The baseline architecture used for a Neutral Hosting feasibility study includes a CBRS MOCN in accordance with the 3GPP EPS system architecture as specified in 3GPP TS23.401, as published by 3GPP, and other associated specifications. In such cases, RAN (Radio Access Network) sharing is in use between multiple EPCs as specified in 3GPP TS 23.251. Each EPC (Evolved Packet Core) is associated with a PLMN-ID (Public Land Mobile Network Identifier). UEs use the Shared CBRS RAN for connecting to their selected PLMN. For CBRS spectrum management, interaction between the Shared CBRS RAN and SAS (Spectrum Access System) is assumed. A high level view of the baseline architecture is illustrated in FIG. 7. FIG. 8 illustrates a Functional breakdown with MOCN GW (gateway).

FIG. 9 illustrates public network to neutral host transitions with MOCN GW.
The MOCN GW (GateWay) acts similar to the functional implementation for LTE (Long Term Evolution) based NH (Neutral Host) operation.
   The LTE S1-C/S1-U is replaced with N2/N3 interfaces for NR (new radio).
The RAN network deployed in the enterprise is shared across enterprise operation and across one or more MNO PLMNs.
The RAN functions of CU (Central Unit)/DU (Distributed Unit)/RU (Remote Unit) will be deployed in the enterprise network.
The user authentication, IP (Internet Protocol) allocation, and QoS (Quality of Service) operations are managed from the MNO (Mobile Network Operator) core.
MOCN GW support will keep it uniform across LTE and NR networks.

3GPP Rel-15 (Release 15) Based NR SA (Stand Alone) NH Operation
The enterprise network includes the MNO-PLMN along with the other PLMNs in its broadcasts.
UE is provisioned with the MNO-PLMN; Procedures used to find the LTE enterprise network for camping is used for 3GPP Rel-15 based NR SA enterprise network camping.
   Transitioning from LTE macro to enterprise NR.
      Macro network populates the SIB24 listing the enterprise NR cells as neighbors;
   Transitioning from NR macro to enterprise NR.
      Macro network populates the SIB3 listing the enterprise NR cells as neighbors.

### SUMMARY

In at least some embodiments, a system is provided that includes an Identifier Mapping Database (IMD), which is located within a Private CBRS/Non-Public Network (PCNN). The IMD enables the mapping of Mobile Network Operator (MNO) identifiers to PCNN identifiers. An MNO IMD is located within an MNO network, and the MNO IMD maps PCNN identifiers to MNO identifiers. As a result, the MNO stores information via which a UE in a target notification region can be identified, and an alert message can be sent to the UE in a target notification area.

In at least some embodiments, the MNO network determines identification information of an endpoint (e.g., an end user or a user of a mobile phone or another network device) within a network, based on identifiers of the MNO (by accessing the IMD). The MNO sends the identification information to a private network. An alert message is routed, by the private network, to the endpoint based on the identification information. Based on information in the alert message, information associated with a target notification area is provided to a private network gateway by a Multi-Operator Core Network Non-Public (MOCN). In at least some embodiments, the network includes multiple MNOs. A single MNO is chosen for performing the determination of the identification information. The choice of which MNO is used is based on the target notification area and a Neutral Host (NH) within the target notification area. The private network is configured to route the message provided from only one of the MNOs. A private network device retrieves a message, including emergency alerts. The private network device determines the destination information of nodes where the broadcasts are intended to be sent based on a target notification area indicated in the message.

In some embodiments, a message is sent from a notification provider to an MNO and then forwarded by the MNO to a network device. The message is received at a network device, and the notification includes information about a target notification area. A private Access Point (AP) is determined by a message received at a network device. The AP can be used to broadcast an alert message to the UEs at the endpoints. A network device matches the endpoint sites to the target notification area, allowing the alert message to be sent to the endpoint sites.

In some embodiments, APs for a target notification region are identified. Target endpoints are determined for sending the alert message by a network device of a private network, and the network device matches the endpoint sites to the target notification area. In some embodiments, the contents of messages from different MNOs are combined, and duplicate alert messages are removed. In some embodiments, target notification areas are combined based on notifications received from the different MNO cores.

### BRIEF DESCRIPTION OF THE DRAWINGS

The disclosed method and apparatus, in accordance with one or more various embodiments, are described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration, these drawings are not necessarily made to scale.

FIG. 1 is a simplified illustration of the architecture of a communication system in which a UE (User Equipment) can receive emergency alerts from one or more Mobile Network Operator (MNO) networks

FIG. 2 is a block diagram of the architecture of a system for translating private network identifiers to MNO identifiers for receiving emergency alerts.

FIG. 3 is a block diagram of the architecture of NIMS SBA Architecture for receiving emergency alerts.

FIG. 4 is a block diagram of an S6a/S8-based neutral host architecture for receiving emergency alerts.

FIG. 5 is a block diagram of a neutral host roaming architecture for receiving emergency alerts.

FIG. 6 illustrates an S6a/S8-based neutral host Architecture.

FIG. 7 is an assumed baseline architecture for CBRS (Citizens Broadband Radio System) MOCN (Multi-Operator Core Network).

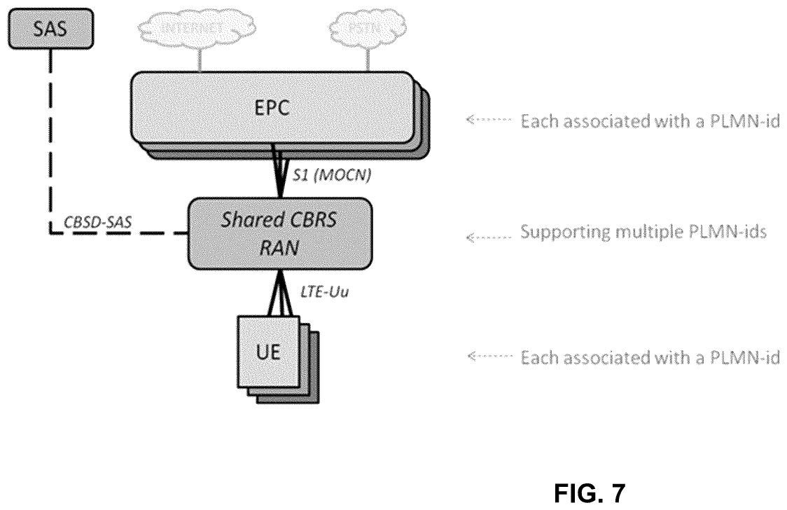

FIG. 8 illustrates a Functional breakdown with MOCN GW (gateway).

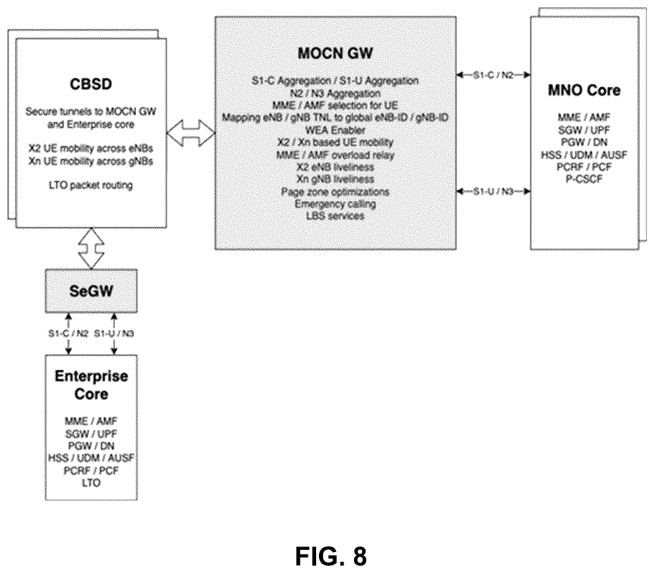

FIG. 9 illustrates public network to neutral host transitions with MOCN GW.

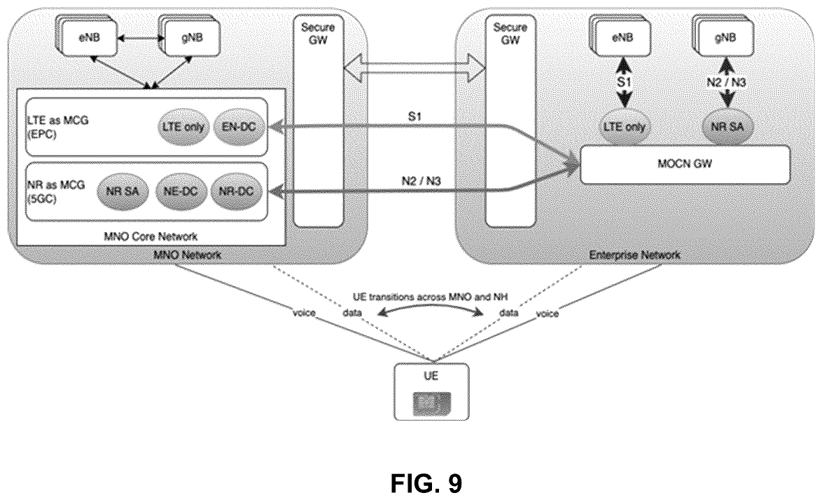

FIG. 10 is a map of FCC Economic Areas.

FIG. 11 is an illustration showing UE Idle Mode transitions from Macro to NH.

FIG. 12 is an illustration showing modifying MNO specific TAC-ID and Cell-ID in Macro to NH connected mode.

FIG. 13 is an illustration showing modifying MNO specific TAC-ID and Cell-ID in NH to NH connected mode.

FIG. 14 is an illustration showing private CBRS/Non-Public network and MNO identifier translation.

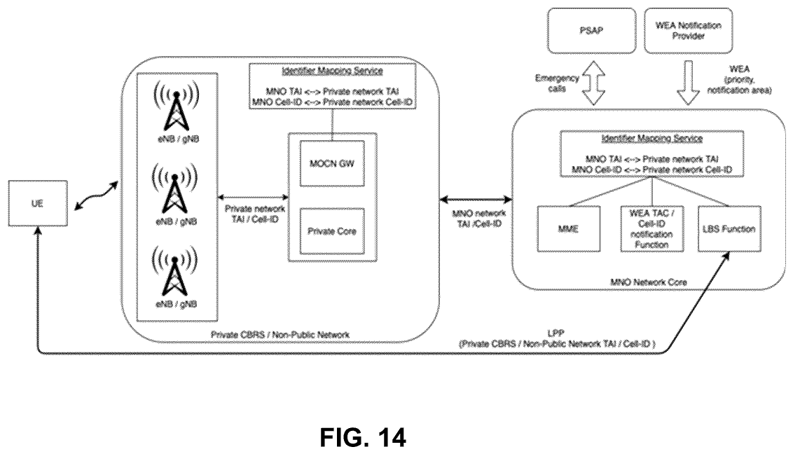

FIG. 15 is an illustration of Neutral Host Registration Flow.

FIG. 16 is an illustration of UE Attach Neutral Host Flow.

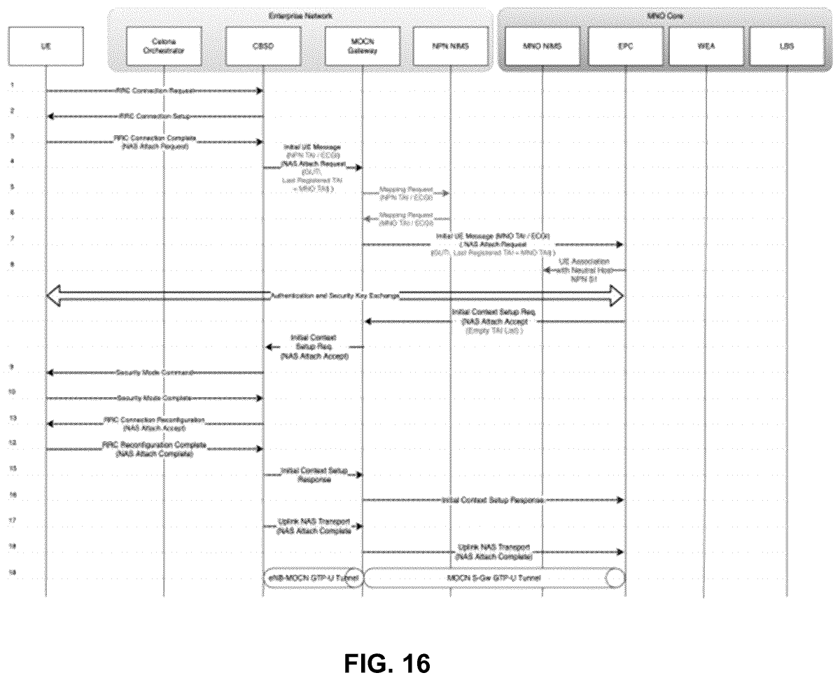

FIG. 17 is an illustration of UE Attach back on MNO Flow.

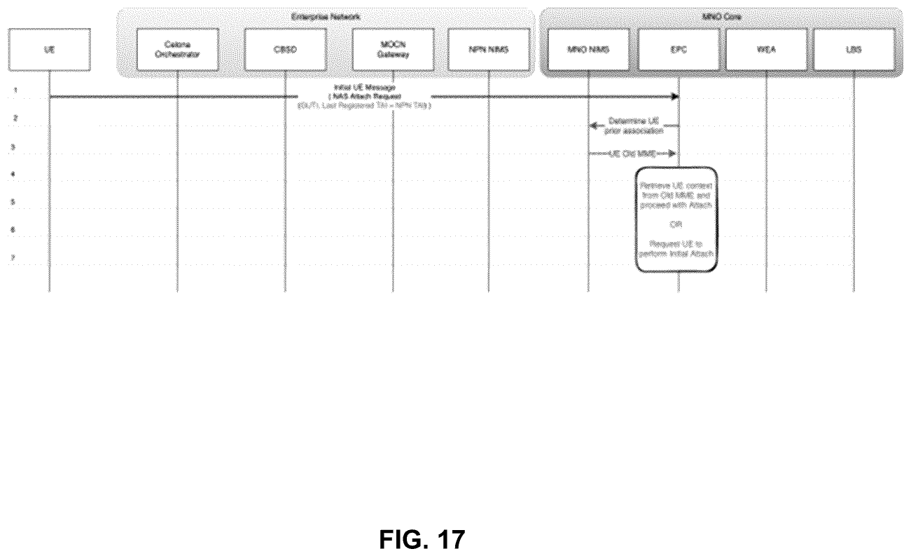

FIG. 18 is an illustration of WEA on Neutral Host.

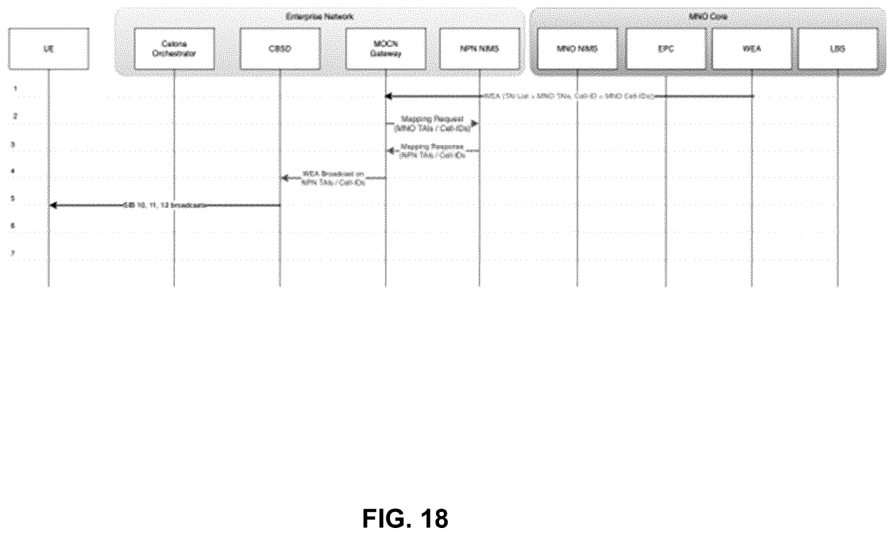

FIG. 19 is an illustration of LPP on Neutral Host.

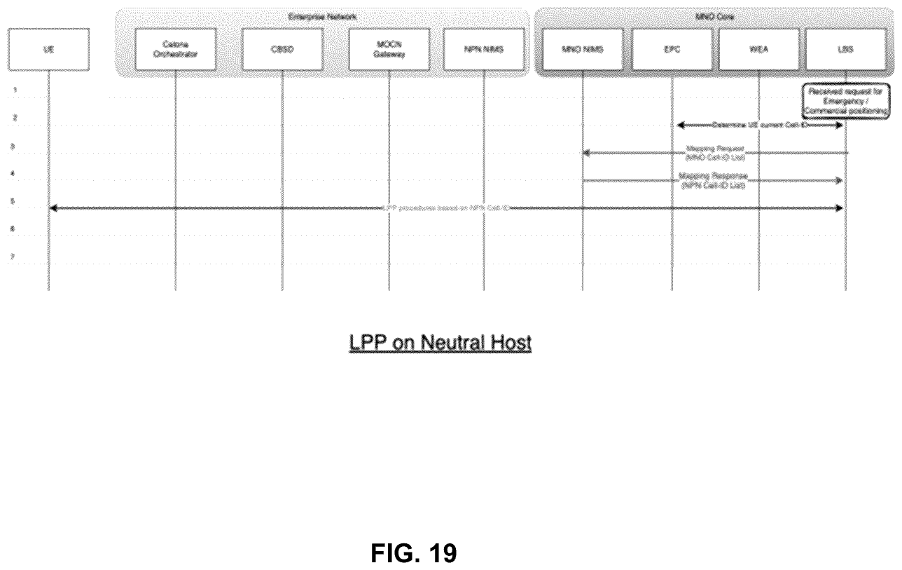

FIG. 20 is an illustration showing shared CBRS RAN-MNO Coupling: Venue/Enterprise Use Case.

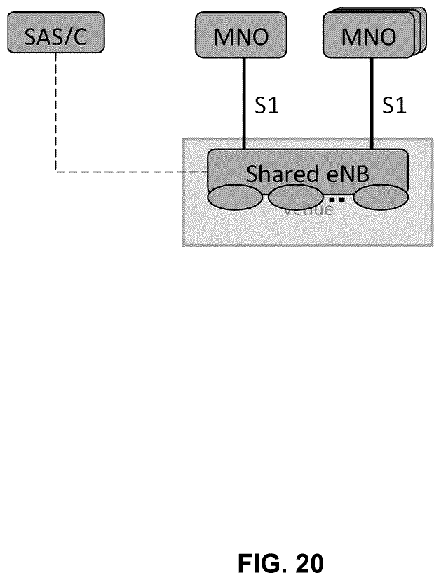

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

The disclosed method and apparatus provide a method and apparatus by which Public Warning System (PWS) messages or other emergency messages can be directed to a subset of APs (i.e., eNBs/gNBs) within a private network. In some embodiments, the private network operates using a Citizens Broadband Radio System (CBRS) network architecture. In addition, in some embodiments, location components of a Mobile Network Operator (MNO) network, such as an Evolved Serving Mobile Location Center (E-SMLC), can request a particular UE (User Equipment) that is communicating through the private network to provide location information in response to requests made in accordance with Location Positioning Protocol (LPP) messaging between the MNO network location component and the UE. In some embodiments, the LPP messaging is communicated on a secure tunnel (Security Labeling service (SLs) interface) that allows the contents of such communications to only be accessible to the UE and the network location component (e.g., the E-SMLC). In some such embodiments in which the response to the request includes information related to APs associated with local Tracking Area Identifiers (TAIs) and local AP identifiers (i.e., eNB/gNB IDs and TAIs that may not be unique for all Public Land Mobile Networks (PLMNs)), a location component within the MNO network provides a mapping between the local (i.e., private network) AP and a local MNO AP that is unique within the MNO network.

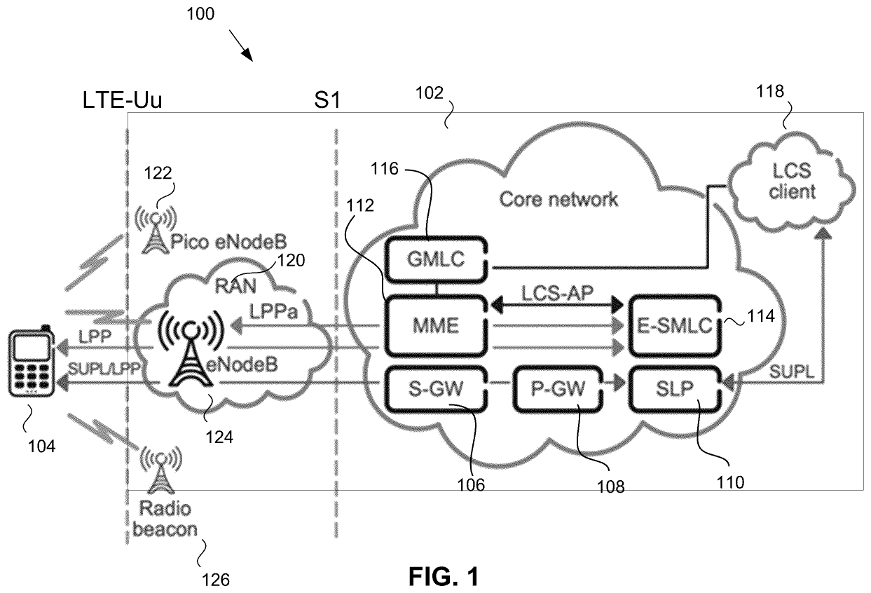

FIG. 1 is a simplified illustration of the architecture of a communication system 100. The communication system 100 includes MNO networks 102, a UE 104, an SGW 106, a PGW 108, an SUPL Location Platform (SLP) 110, Mobility Management Entity (MME) 112, an E-SMLC 114, a Gateway Mobile Location Centre (GMLC) 116, a Secure User Plane Location (SUPL) 114, an LCS client 118, a RAN 120, a pico gNodeB 122, eNodeB 124 and a radio beacon 126.

In the communication system 100, a UE 104 receives emergency alerts from one or more MNO networks 102. In addition, the UE 104 can answer requests for position location information sent to the UE 104 by the E-SMLC 114 within the MNO network 102 in response to the UE 104 placing an E-911 emergency call. The SGW 106 resides in the User Plane (UP). The SGW 106 forwards and routes packets to and from the RAN 120 and the PGW 108. The SGW 106 is a local mobility anchor for an inter-AP handover and mobility between networks. The PGW 108 acts as an interface between an LTE network and other packet data networks. The PGW 108 is the anchor point for network mobility and may act as the Policy and Charging Enforcement Function (PCEF), manage the Quality of Service (QoS), and provide packet inspection. Secure User Plane Location (SUPL) are communicated between PGW 108 and LCS client 118.

### E-911 Calls in LTE

Generally, when a UE 104 places an E-911 emergency call, the call is routed to an LCS client 118. For an E-911 call, the particular LCS client 118 is a Public Safety Answering Point (PSAP). The PSAP, in coordination with an E-SMLC 114 within the MNO network 102, sends a request for the UE 104 to provide information regarding the location of the UE 104. The response provided by the UE 104 to the request for position location information may take many forms. In many cases, the response includes information that includes the identity of one or more components of the MNO network 102. For example, in some embodiments, the identity of the components of the MNO network 102 may include a Cell-ID of the pico eNB 122/gNB 124, the Cell-ID of the pico eNB 122/gNB 124, or an identifier associated with a radio beacon 116. Components within the MNO network 102, such as the E-SMLC 114, have a database of locations for each of the MNO components that might be identified in the response from the UE 104. Using one or more techniques for locating the UE 104, the location of the UE 104 can be determined from the information provided by the UE 104 in its response.

### Request for Commercial Location Based Services in LTE

Similar to the case in which an E-911 call is placed, when the UE 104 requests access to services that require the Location Service (LCS) client 114 to determine the location of the UE 104, the associated LCS client 118 attains the location of the UE 104, based on information provided by the UE 104. In some cases, the UE 104 provides the information in response to a request from the MNO network 102. Alternatively, the UE 104 provides the information in anticipation of the LCS client 118 needing to locate the UE 104. In either case, the E-SMLC 114 within the MNO network 102 provides the location of the UE 104 by calculating the location of the UE 104 with the assistance of the database of locations for each of the components of the MNO network 102 at issue, similar to the process that takes place in the case of an E-911 call, as noted above.

Emergency Messages Sent through the Public Warning System (PWS) in LTE

In cases in which an emergency message is sent from an LCS client 118, such as a source for Wireless Emergency Alerts (WEAs) from the Earthquake and Tsunami Warning System (ETWS), a group of eNBs/gNBs 114 (and possibly pico eNBs/gNBs 118 and radio beacons 116) within a particular geographic area are identified to receive the warning based on their location. The MNO has a complete list of all the pico eNB 122/gNB 124 and other such transmitters through which such alerts can be sent, and the messages can be directed to each using the Cell-ID of each such transmitter and also using a Tracking Area Identifier (TAI). The TAI identifies groups of transmitters (in the example of FIG. 1, one such group includes pico eNB 122/gNB 124), and the groups of transmitters are located within a particular geographic area. Thus, by sending a message with a TAI, the UEs within the geographic area of the group of transmitters using the TAI receive the emergency message.

### Private Networks

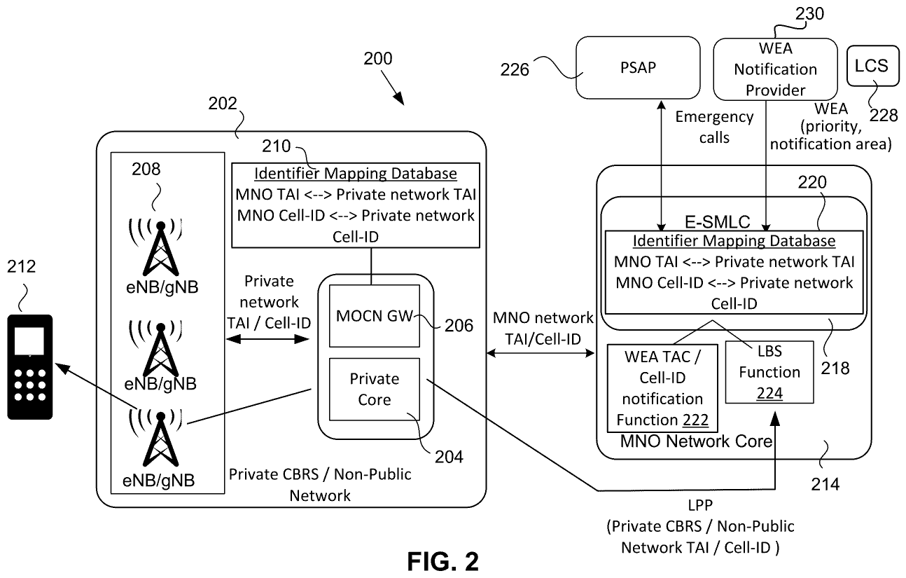

FIG. 2 is a simplified illustration of the architecture of a communication system 200 comprising components that operate in accordance with some embodiments of the disclosed method and apparatus. A Private CBRS/Non-Public Network (PCNN) 202 comprises a private network core 204, a Multi-Operator Core Network (MOCN) gateway 206, a plurality of eNBs/gNBs 208, an Identifier Mapping Database (IMD) 210, a UE 212, an E-SMLC 218, an MNO network core 214, an IMD 222, a PSAP 226, an LCS 228 and a WEA notification provider 230.

When a UE 212, such as a cellular telephone, communicates through an eNB 208, the communication between the UE and the core 204 carries a TAI and a Cell-ID (hereafter referred to collectively as “identifiers”). The Cell-ID serves as an eNB identifier. The identifiers are local to the PCNN 202. That is, the identifiers are unique within the PCNN 202. However, the identifiers may not be unique when other PLMNs are taken into account, such as the MNOs to which the PCNN 202 may be in communication through the MOCN gateway 206. Therefore, the PCNN identifiers are not useful for an MNO attempting to identify the transmitter associated with the Cell-ID or TAI.

Upon receiving the communication, in some embodiments, the MOCN gateway 206 accesses information stored within the IMD 210 to map the local PCNN identifiers to MNO identifiers for a particular MNO network. The particular MNO is determined based on information received in the communication from the UE 212. That is, the UE 212 provides information indicating to which MNO the UE 212 subscribes. The local PCNN identifiers are then mapped to the MNO identifiers associated with the MNO to which the UE 212 subscribes. In some embodiments, there is only one local Cell-ID for each MNO Cell-ID in the IMD 210. However, in other embodiments, an MNO Cell-ID may be mapped to more than one local Cell-ID. Similarly, in some embodiments, only one local TAI exists for a particular MNO TAI within the IMD 210. However, in other embodiments, an MNO TAI may be mapped in the IMD 210 to more than one local TAI.

Use of the Same TAC-ID and Cell-ID for Neutral Host Deployments

In some embodiments, MNOs all align to use the same TAC-ID and Cell-ID for each neutral host deployment.

TAC-ID

In some embodiments, the TAC can be to specify the “high byte” to use a specific value with the freedom for the individual neutral host deployments to use any of the 256 “low byte”.

For LTE and the currently available devices in the market for 5G NR do not support independent TACs per PLMN in the SIB broadcasts and a single value needs to be used for all devices camping on the neutral host cell.

The support for per-PLMN TAC support feature can be introduced in the 5G NR neutral host networks but will require backward compatibility until the legacy devices are sunset. Once per-PLMN TAC-ID can be supported, this aspect becomes a non-issue.

Cell-ID

In some embodiments, the Cell-IDs are uniquely assigned and when interpretable in the individual MNO cores and enterprise network.

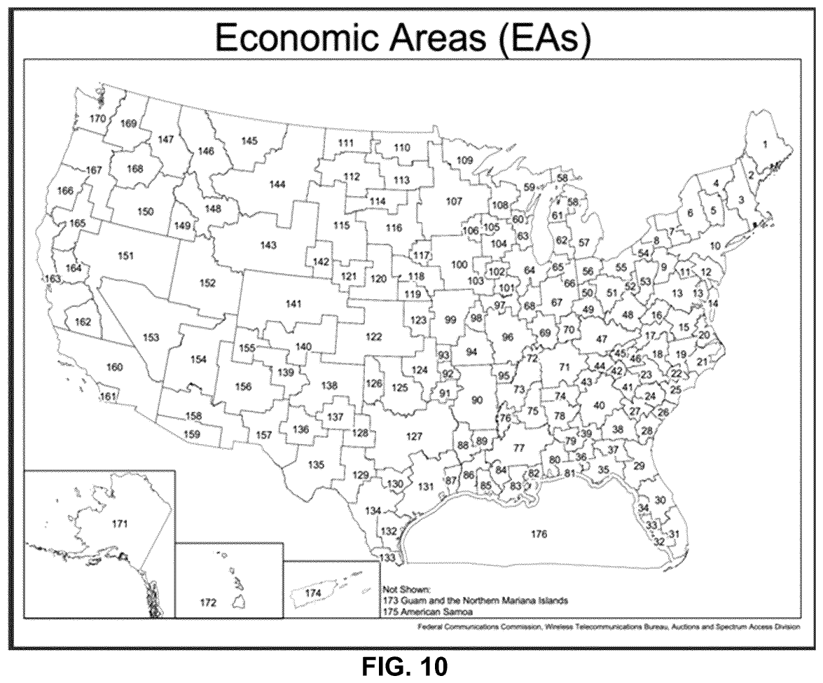

FIG. 10 is a map of FCC Economic Areas.

Identifier Assignments Provided from MNO
TAC-ID
High Byte=0xDE
Low Byte=A single assignment based on FCC economic area
Cell-ID range=995000-999999

### Aspects to Address

The above information needs to be ratified with all the MNOs and MSOs.
Single TAC-ID within a region will impact UE camping on neighboring private networks. The current procedures provide isolation of private network by using distinct TAC-IDs and private networks providing reject code of #15 to prevent UE reentering a private network where the UE does not have valid credentials.
The Cell-ID range of 5000 is provided. With country wide deployments of neutral hosts, this will not allow for uniquely resolving Cell-IDs within the MNO cores.
Need to understand if the Cell-ID needs to be unique within an MNO or can be interpreted together with PLMN-ID and/or TAC-ID. How are the measurement reports handled in the MNO core for location determination?
   a) EHPLMN (UE provisioned) versus b) EPLMN (Sent in the NAS procedures from network to indicated that it is a equivalent home network)
ID: TAC-ID and Cell-ID
NH: Network Arch: a) MOCN GW; b) S6a/S8
System Camping: a) LTE or Rel-15 NR (PLMN based scans); b) PNI-NPN+CAG Rel-16 and beyond
   Proposal 2 In this proposal, the SIB broadcasts are based on private network SHNI TAC-ID and Cell-ID. When the MNO UEs associates with the neutral host cell, the UE is provided MNO specific TAC-ID and Cell-ID in RRC connected mode.

The neutral host network populates its SIB parameters based on the OnGo Alliance identifiers purchased with the TAC-ID derived from the IBNs and the Cell-ID based the eNB-ID/gNB-IDs procured from OnGo Alliance. The neutral host cell apart from SHNI also populates the MNO PLMN-IDs in its SIB broadcasts.

When the MNO UE attaches to the neutral host, the UE's MNO association is learnt. Based on the MNO association, the TAC-ID and Cell-ID parameters are modified in RRC Connected mode based on the individual MNO authorized TAC-ID and Cell-ID. The MNO UE continues to use this MNO specific TAC-ID and Cell-ID while operating on a given neutral host cell.

The transitions across the macro network and neutral host network are discussed in the following sections.

UE Idle Mode Transitions from Macro to NH

The UE based on SIB broadcasts from the macro network or based on the out-of-service (OOS) scans, finds and transitions to the neutral host network.
Option A: Additionally in Connected mode during the Attach/RRC Configuration, UE obtains a TAI list when it attaches to an LTE network. This list shows the tracking areas where the LTE network believes a UE is located and within which a UE can travel without TAU. The neutral host network also includes the TAC-ID used in the SIB broadcast in the TAC-ID list to avoid the UE sending TAU upon Idle/Inactive transitions from one neutral host cell to another.
   Upon transitioning to Idle mode/Inactive mode, the UE continues to use the TAC-ID and Cell-ID provided in connected mode to the UE. When the UE moves from one neutral host cell to another, the UE sees a change of TAC-ID in the new neutral host cell SIB broadcast and if this TAC-ID is present in the TAC-ID list provided to the UE, the UE does not initiate a TAU. The UE continues to use the TAC-ID provided to it in connected mode.
   When the UE reenters connected mode, the neutral host network sense the MNO UE and provides the MNO authorized TAC-ID and Cell-ID to the UE.
Option B: As an alternative, the UE is not provided the TAC-ID list including the SIB broadcasted TAC-ID from neutral host cell.
   With this option when the UE goes through idle HO, the UE will see a change in TAC-ID and will trigger the UE to send a TAU entering connected mode. The UE is provided the MNO authorized TAC-ID/Cell-ID while in connected mode.

To prevent the UE from sending Attach or TAU with the TAC-ID and Cell-ID from the SIB broadcasts, the neutral host network needs to ensure that these parameters are switched prior to the NAS signaling messages are exchanged.
UE provides the InitialUE-Identity¹ and selectedPLMN-Identity is provided in
   LTE RRCConnectionRequest/RRCConnectionSetupComplete [Ref 3GPP TS 36.331]
      S-TMSI>=<MMEC> <M-TMSI>; SAE Temporary Mobile Subscriber Identity; Locally identify a UE in short within a MME group (Unique within a MME Pool) [Ref 3GPP TS 23.003]
      MMEC=MME Code; To identify an MME uniquely within an MME Group.
      selectedPLMN-Identity: Index of the PLMN selected by the UE from the plmn-IdentityList included in SIB1.
   5G NR RRCSetupRequest/RRCSetupComplete [Ref 3GPP TS 38.331]
      5G-S-TMSI>2:=<AMF Set ID> <AMF Pointer> <5G-TMSI>[Ref 3GPP TS 23.003]
         ng-5G-S-TMSI-Part1 (included in RRCSetupRequest): The rightmost 39-bits of 5G-S-TMSI. The 5G-S-TMSI is comprised of the AMF Set ID, AMF Pointer and 5G-TMSI.
         ng-5G-S-TMSI-Part2 (included in RRCSetupComplete): The leftmost 9 bits of 5G-S-TMSI
      selectedPLMN-Identity: Index of the PLMN or SNPN selected by the UE from the plmn-IdentityList or npn-IdentityInfoList fields included in SIB1.
The neutral host network is provisioned with the MNO/MVNO association with the MMEC identifier and the selected PLMN identity. There are two possible scenarios ¹From 3GPP TS 23.003: Mapping of identifiers between NR and LTE 5G <MCC> maps to EPS <MCC>5G <MNC> maps to EPS <MNC>5G <AMF Region ID> and 5G <AMF Set ID> maps to EPS <MMEGI> and part of EPS <MMEC>5G <AMF Pointer> map to part of EPS <MMEC>5G <5G-TMSI> maps to EPS <M-TMSI>²From 3GPP 23.003: The format and size of the 5G-GUTI is therefore the following: <5G-GUTI>=<GUAMI> <5G-TMSI>, where <GUAMI>=<MCC> <MNC> <AMF Identifier> and <AMF Identifier>=<AM F Region ID> <AMF Set ID> <AMF Pointer>

MCC and MNC shall have the same field size as in earlier 3GPP systems. 5G-TMSI shall be of 32 bits length. AMF Region ID shall be of 8 bits length. AMF Set ID shall be of 10 bits length. AMF Pointer shall be of 6 bits length.
First time attaching to a network (like a power on scenario)—in this case UE sends Random value as UE identity (there is no S-TMSI here) and a selected PLM N identity (this is picked from the list of PLMNs that eNB is broadcasting and is in the PLMN or EPLMN list stored on the SIM). Since we have separate S1 connection for each PLMN between eNB and MOCN, the MOCN gateway will pick the MNO based on this connection.
If the UE is re-attaching/going active from idle—in this case UE sends S-TMSI (which contains the MME code) as well as the selected PLMN identity which will identify the MNO network to use. Note that MOCN gateway will use the MME code to identify the MME in a pool (S1-Flex supported connectivity).
In summary, UE always communicates to eNB the PLMN identity that it selected to connect
The neutral host network sends the RRCConnectionReconfiguration providing the modified SIB1 parameters including the TAC-ID and Cell-ID associated with the MNO/MNVO
These are performed with SRB1 without allowing NAS messages to be forwarded to the packet core network until RRCConnectionReconfigurationComplete is received.
The NAS messages received from the UE after the RRCConnectionReconfigurationComplete are forwarded to the packet core.
eNB records the S-TMSI for which the TAC-ID and Cell-ID has been changed to the MNO identifiers. Subsequent connections, the reconfiguration procedures are not performed. When the UE moves out a given cell, this information is deleted so that when the UE reenters, this procedure can be run.

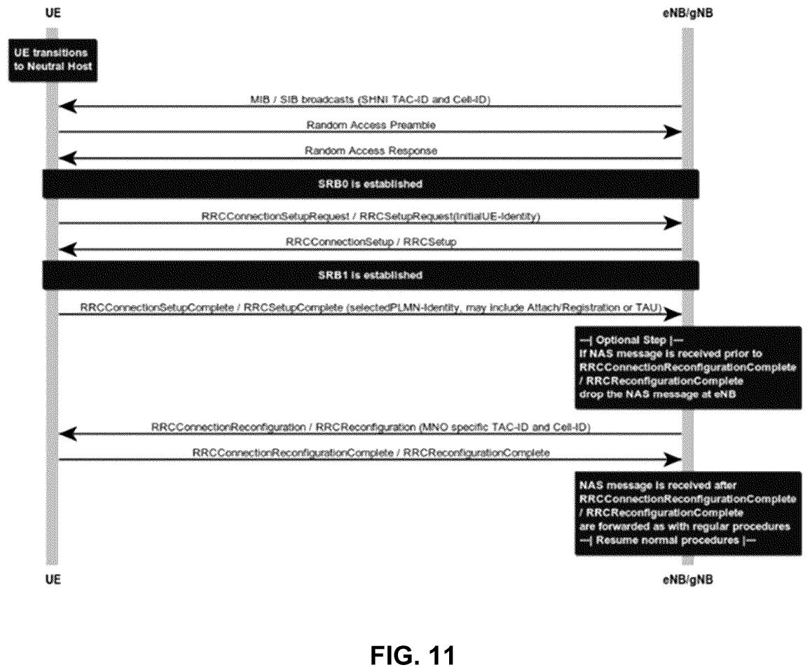

FIG. 11 is an illustration showing UE Idle Mode transitions from Macro to NH.

UE Idle Mode transitions from NH to NH

The UE idle transitions from source NH cell to target NH cell in the enterprise campus is addressed in this section.

The UE is provisioned with the MNO TAC-ID when the UE was in connected on a NH cell on that enterprise campus. The UE may potentially may also be provided the SHNI TAC-ID as part of the TAI List provisioned from the MNO MME/AMF.

The UE remains in idle mode and uses the SHNI TAC-ID and Cell-ID from the SIB broadcasts. If the UE is provisioned with the SHNI TAC-ID in the TAI List, the UE will remain in idle mode when the UE transitions cells in idle mode. Otherwise, the UE will go into connected mode on the target cell and will be provisioned the MNO specific TAC-ID and Cell-ID to use on the target NH cell as described in section 0.

When the UE goes into connected mode on target NH cell, the UE is provisioned with the MNO specific Cell-ID associated with the target of the NH Cell.

UE Connected Mode transitions from Macro to NH

This section discusses the details of the UE transitioning from the macro network to the neutral host network.

When the UE transitions from one cell to another in connected mode, the target neutral host cell provides the updated set of MNO specific TAC-ID and Cell-ID parameters.

The UE is provisioned with the MNO specific TAC-ID and Cell-ID once the UE transitions into the NH.

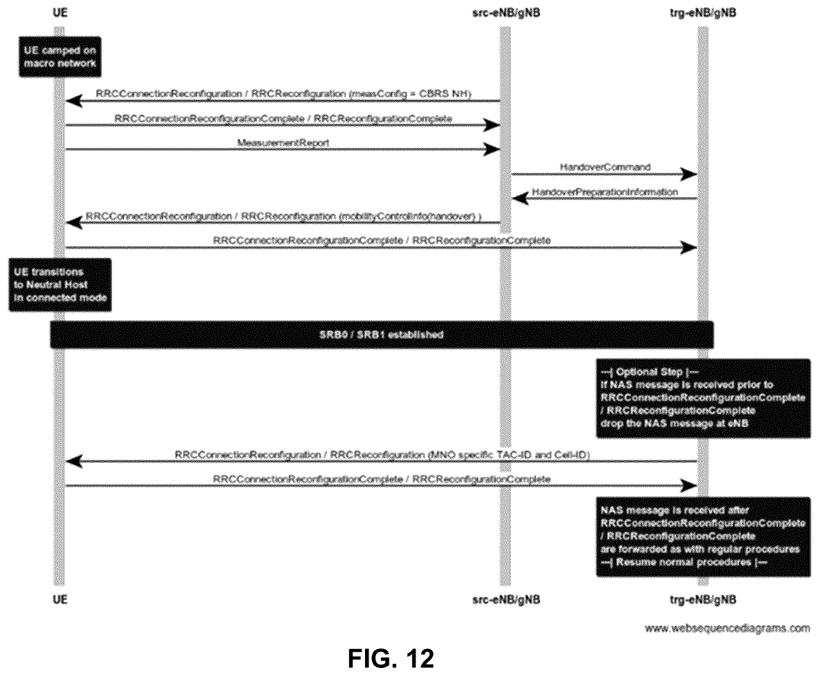

FIG. 12 is an illustration showing modifying MNO specific TAC-ID and Cell-ID in Macro to NH connected mode.

UE Connected Mode transitions from NH to NH

This section discusses the details of the UE transitioning from a source NH cell to a target NH cell within an enterprise campus.

As part of the handover procedures, the RRCConnectionReconfiguration/RRCReconfiguration message carries the MNO specific TAC-ID and Cell-ID of the target NH cell.

Note that the handover procedures are handled within the enterprise network either as X2/Xn handover supported through interactions across eNB/gNB or as S1/NG handover supported through interactions across eNB/gNB and MOCN GW. In both mechanisms, the MNO core network is abstracted from the mobility procedures within the enterprise NH campus.

Note as well that the measurements of cells needs for the handover procedures are supported based on the SHNI based NH configurations and handled within the neutral host network.

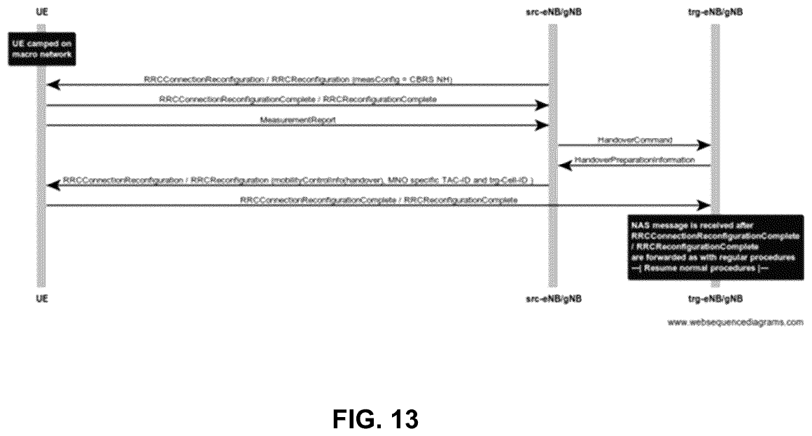

FIG. 13 is an illustration showing modifying MNO specific TAC-ID and Cell-ID in NH to NH connected mode.

Macro to Neutral Host handover scenarios

With the UE is subscribed to MNO-1 and UE is currently camped on the roaming network MNO-2. The UE transitions to the Neutral Host network.

MMEC identifier will point to the roaming partner MNO (MNO-2) rather than the home network (MNO-1) when UE transitions to the neutral host from a roaming partner MNO (MNO-2). Although this may not be typical with the USA MNO devices, it may have implications with preferred camping for international roaming agreements.

NHN supports only MNO-2

Expectation: It is fine to be on NHN operating with MNO-2 as long as there is no MNO-1 macro network coverage.

Solution: UE is on the most preferred network and no further steps are required.

NHN supports only MNO-1, but MNO-2 macro does not transition the UE to the MNO-2 NHN

Expectation: The UE is offloaded to NHN supporting MNO-1

Solution: UE performs HPPLMN scans to find the NHN and transitions to the NHN in idle mode. UE may be provisioned with geofence of the available NHNs and the UE used that to pro-actively transition to the NHN supporting MNO-1.

NHN supports both MNO-1 and MNO-2

Expectation: The UE should camp on the NHN, but with MNO-1 configuration and avoid roaming with MNO-2.

Solution: UE performs HPPLMN scans to find the NHN and transitions to the NHN in idle mode. UE may be provisioned with geofence of the available NHNs and the UE used that to pro-actively transition to the NHN supporting MNO-1.

NHN support MNO-2 and UE camped on MNO-1 macro poor coverage

Expectation: Given the poor indoor coverage for MNO-1 macro, UE will ping-pong between the MNO-2 NHN and MNO-1 macro network. The UE should prefer MNO-2 NHN until MNO-1 network coverage is stable.

Solution: The UE recognizing the ping-pong and fingerprinting the behavior for this site, prevents HPPLMN scans from returning the UE to MNO-1 macro network and leverage the MNO-2 NHN coverage. UE may be provisioned with geofence of the available NHNs and the UE used that to pro-actively transition to the NHN supporting MNO-2 for roaming purposes with the MNO-1 realizing poor coverage for their MNO-1 at that NHN location.

Proposal 3

Each MNO obtains a semi-independent PLMN-ID for enterprise neutral host operation.

The enterprise network supporting neutral host is deployed with the TAC and Cell-ID associated with the SHNI. This information is provided to the MNOs. The expectation is that these TACs and Cell-IDs are unique within each of the MNOs PLMNs used by the UE to camp on the neutral host network.

This MNO identified PLMN for neutral host is populated in the SIM credential PLMN list for the UE to camp on the enterprise network. The relative prioritization of this MNO identified PLMN for neutral host camping can be specified in the PLMN list. Additionally, radio procedures for transitioning from the macro network to the enterprise network can be coordinated based on SIB broadcasts from the macro network.

Current TAC and Cell-ID assignment procedures from CBRS

There are 6 TAC per IBN purchased assigned. There are 10K IBNs, resulting in 60K TACs that can be associated with the IBN purchases. TAC is a 16-bit identifier. 2\hat{ }16-60K=5536 can be “locally” allocated and independently purchased from OnGoA.

The Cell-ID are individual purchased and associated with the SHNI to form the ECGI.

Aspects to Address

Initial input received is that this proposal is not a preferred approach. This preference needs to be ratified with all the MNOs and MSOs.

Can a semi-independent PLMN be accommodated for NHN in the MNO cores together with a larger space of TAC-ID/Cell-ID supported?

Proposal 4

The TAI and Cell-ID mapping across the Private CBRS/Non-Public network and the individual MNO network assigned identifiers are shared between the two entities.

The Private CBRS/Non-Public network cell broadcasts are based on the Private CBRS/Non-Public network TAI and Cell identifiers. The MNO PLMNs are also broadcasted on the neutral host cells.

The signaling messages exchanged between the UE Private CBRS/Non-Public network are based on the TAI and Cell identifiers of Private CBRS/Non-Public network. These signaling messages are transitioned to MNO specific TAI and Cell identifiers.

### MNO MME Implications

The MNO MME maintains a mapping between the Private CBRS/Non-Public network TAIs with the corresponding one identified in the MNO network. A given MNO network may be connected to multiple Private CBRS/Non-Public networks and will need to maintain the mappings based on the S1 connectivity established with the MOCN GWs.

Handling Last Visited Registered TAI

UE includes the ‘Last Visited Registered TAI’ in the Attach Request message. The UE when it previously Attached to a Private CBRS/Non-Public network, it will provide the Private CBRS/Non-Public network TAI.

MNO MME can either interact with the Private CBRS/Non-Public network to retrieve the prior context of the UE or ignore that and proceed to reestablish the full UE context again. When active sessions need to be transitioned from Private CBRS/Non-Public network to the MNO network, retrieving the prior established information will be required for realtime services like VoLTE.

Handling TAI List when UE is Operating in Private CBRS/Non-Public Network

The MNO MME in the Attach Accept message may provide a TAI List providing the tracking areas where the UE can transition without sending a TAU Update. The TAI List needs to match the TAIs deployed by the Private CBRS/Non-Public network.

The MNO MME when operating in the Private CBRS/Non-Public network, needs to provide the TAI list used by the Private CBRS/Non-Public network if it wants to manage the UE transitions across TAIs within the Private CBRS/Non-Public network.

One option for the MNO MME is to not provide a TAI List. Given that the Private CBRS/Non-Public network of each specific deployment footprint will be fairly small, not including the TAI List will be the common practice and will also limit the ‘Paging’ area for the UE.

Handling WEA/PWS Messages

Approach 1—WEA/PWS Delivered to Mapped TAI/Cell-ID

For WEA/PWS message, the MNO network determines the TAI/Cell-ID based on MNO identifiers and sends the information to the Private CBRS/Non-Public network.

When the CMAS/ETWS information along with the notification area

information provided to Private CBRS/Non-Public MOCN GW and the MOCN GW internally decides on where to route the WEAs—to all the eNB s that are located within the notification area. The actual footprint of the APs can be ignored given the small footprint of these cells and focus sufficient to based on the WEA/PWS broadcast based on the eNB location information.

With multiple MNOs, WEA/PWS duplicates initiated from the different MNOs should be avoided. The Private/Non-Public networks uses the WEAs provided from only one of the MNOs. The choice of the MNO may be based on specific regions to deliver the WEA/PWS messages to the Private CBRS/Non-Public networks supporting NH withing that region.

Alternative Approaches to Handling WEA/PWS Message

These alternative approaches are proposed when the Private CBRS/Non-Public network and MNO identifier translation cannot be supported.

Approach 2—Private/Non-Public Direct Connectivity to WEA Notification Providers

The Private/Non-Public network obtain the emergency alerts and support the broadcasts independently. This includes determining the nodes where the broadcasts need to be done based on the notification area(s) indicated in the message.

MNO initiated WEAs does not need to be processed as they the Private/Non-Public networks will handle the WEAs independently.

Approach 3

The expectation is that the WEAs received from the notification provider are forwarded to the Private/Non-Public networks from the MNO including the notification area where the message needs to be delivered. The region(s) Private/Non-Public sites/access points where the information needs to be broadcasted is determine by the Private/Non-Public network matching the cell sites to the required notification area(s).

With multiple MNOs, WEA/PWS duplicates initiated from the different MNOs should be avoided. The Private/Non-Public networks uses the WEAs provided from only one of the MNOs. The choice of the MNO may be based on specific regions to deliver the WEA/PWS messages to the Private CBRS/Non-Public networks supporting NH withing that region.

Approach 4

The expectation is that the WEAs received from the notification provider are forwarded to the Private/Non-Public networks from the MNO including the notification area where the message needs to be delivered. The region(s) Private/Non-Public sites/access points where the information needs to be broadcasted is determine by the Private/Non-Public network matching the cell sites to the required notification area(s).

The received WEAs are delivered as broadcast removing duplicates across MNO by comparing the contents and combine the required area of delivery based on the notification are received from the individual MNO cores.

Handling LBS

The LBS procedures are initiated from the MNO core. The procedures depend on the Private/Non-Public network identifiers for RAT dependent measurements for the UE to report information. The MNO core issues these requests to the UE based on the Private/Non-Public network identifiers. For LPPa and NRPPa procedures, the Private/Non-Public network performs the required translations to the MNO network identifiers to report the information to the MNO core.

This allows for the MNO core network to leverage the existing procedures for WEA/PWS with the translation from the MNO identifiers to the Private/Non-Public network identifiers handled at the MOCN GW.

For LBS with both emergency and commercial positioning, an added supported of using the Private/Non-Public network identifiers translated from the MNO identifier is required to support UE based measurement procedures. The required identifier translations for the network based procedures are handled by the Private/Non-Public network.

Neutral Host Identifier Mapping Service (NIMS)

To align with the SBA architecture model and to allow for more dynamic model for maintaining the mapping of the identifiers between the Private CBRS/Non-Public networks and MNOs, a new service is introduced—Neutral Host Identifier Mapping Service (NIMS).

The NIMS service is supported on the Non-Public network to provide the Private CBRS/Non-Public networks deployed TAIs and Cell-IDs to the MNO NIMS. The MNO NIMS in turn receives the information from Non-Public network NIMS and provides the mapping to the MNO TAIs and Cell-ID.

The identifier mapping needs to be per S1 connection between the Private CBRS/Non-Public network and MNO core, the information exchanged between the Non-Public network NIMS and MNO NIMS needs to interpreted within the context of an S1.

Given that multiple entities both in the Private CBRS/Non-Public networks and the MNO networks require this mapping information, an independent service that can be hosted in an appropriate compute instance is proposed.

### Tradeoff Considerations

Advantages: Supports all relevant services on the enterprise networks for MNO UE to camp on the system.
Disadvantages: Changes in the MNO core are required.

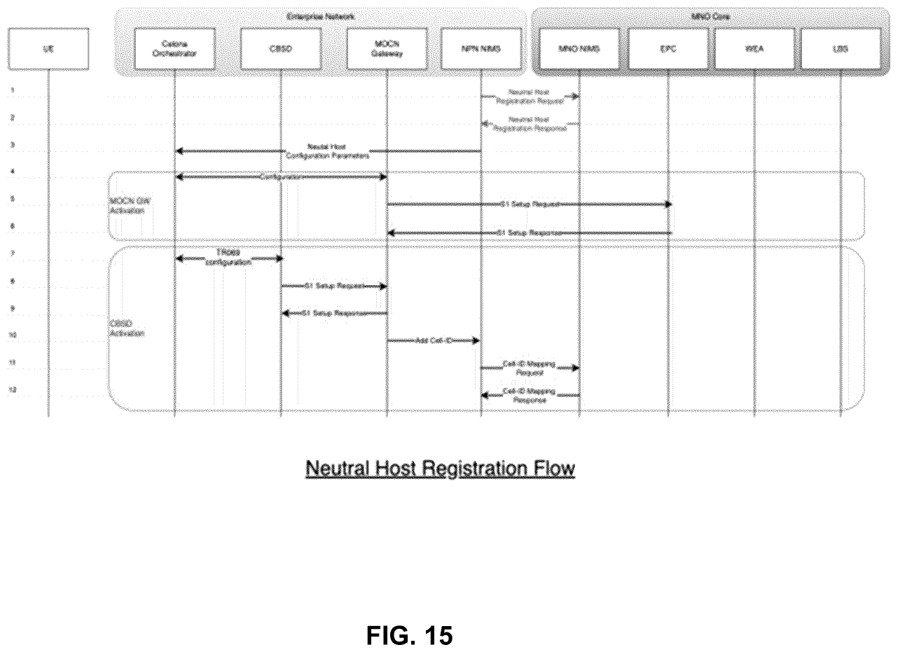

FIG. 15 Flows illustrating identifier mappings for Proposal 3

Uncoordinated PLMNs and Cell Access Info

3GPP Release 14 RRC supports also broadcasting of separate Cell Access Info for PLMNs who prefer to use their own Cell-ID and TAC for the shared RAN cells without any coordination with the other PLMNs. For these Uncoordinated PLMNs separate Cell-ID and TAC info is configured to and broadcasted by the shared CBRS cells.

PLMN-ID Per Network

Use of MOCN requires that each Service Provider (non-MVNO) is associated with a PLMN-ID.

Existing mobile service providers naturally have their own dedicated PLMN-IDs and those can be used directly for identifying those mobile service providers also via the Shared CBRS RANs.

Each Shared CBRS RAN can also support one additional EPC that is associated with the CBRS Alliance PLMN-ID (i.e. CBRS-I).

Limit of 6 PLMN-IDs in SIB1

The list of PLMN-IDs is carried in SIB1 and is limited to 6 entries. This implies that a MOCN RAN can only support 6 (non-MVNO) EPCs (of which one may be associated with CBRS-I).

If one considers that there are currently 4 nationwide operators (MNOs) in the U.S. and at least one regional MNO in many parts of the U.S., then 5 of the available 6 PLMN-ID slots in SIB1 could be allocated to those MNOs, for example, in a deployment in a mall or building. The remaining 6th PLMN ID could be set to CBRS-I.

Connected Mode Handovers

Connected mode handovers depend on the serving RAN receiving UE measurement reports about the available cells on a target frequency. This requires that the source system configures the UE to perform measurements in those specific target frequencies.

As discussed in section 7.4, outbound connected mode handovers should be straightforward as typically the target frequencies within mobile service provider RANs are well known. Due to the nature of CBRS spectrum, the frequencies used by given CBRS deployments may change more frequently and thus pre-configuration may not be feasible. Section 7.3 discusses a few mechanisms by which the mobile service provider may dynamically become aware of the possible frequencies where relevant Shared CBRS RANs in an area operate. In such cases also inbound connected mode handovers can be executed. Otherwise similar idle mode inbound mobility as is used also for inbound mobility to NHNs, is applied.

Support for Private CBRS Deployments

A Private CBRS Network can be deployed as discussed in Private Network Technical Report. This provides compatibility with any 3GPP compliant and band 48 supporting UE.

A private CBRS Deployment can be extended to operate also as a Hybrid CBRS Deployment as discussed in Private Network Technical Report.

Role of Initial Shared CBRS RAN Deployments

Any band 48 supporting 3GPP compliant UE can connect to Shared CBRS RAN. No new features or configurations are required. CBRS band (Band 48) was specified in 3GPP Release 14 and thus the first band 48 enabled UEs are expected to be available late 2017-early 2018. In practice this means that for a few years a significant share of MNO subscriber UEs will not support band 48 and thus are not able to connect to any kind of CBRS system.

Use of Shared CBRS RANs within various premises may however be very beneficial for MNOs already as soon as the first band 48 supporting UEs are available. Typically most venues and other high use environments already have reasonable mobile coverage in place. Shared CBRS RAN can be initially deployed to supply capacity and coverage boosts for such sites. MNO UEs that support band 48 will connect via the onsite Shared CBRS RAN and will likely benefit from superior bandwidth and better signal strength throughout the premises. Also the UEs which do not support band 48 benefit, as there is less competition for the potentially scarce resources via the pre-existing mobile coverage.

Typically new bands are first supported by so called flagship devices and significant amount of those tend to get into market quite rapidly after their initial launch. Also the data usage by these flagship devices tends to be high compared to the overall device population. For these reasons the amount of traffic that can be ‘offloaded’ to Shared CBRS RANs may become significant very quickly.

Investment into a premises specific Shared CBRS RAN is possible either as the deploying Primary MNO or as a participating Secondary MNO. This investment may be a very cost effective way for an MNO to ensure continued availability of good mobile service for all of its subscribers within the premises.

Coupling Between Shared CBRS RAN and MNO

Venue/Enterprise Use Case:

Assumptions:
Shared CBRS RAN is deployed and operated by a RAN Operator (RANO)
RANO may be MNO1 or an entity hired by the MNO1
RANO sets the Cell Access Info and other eNB operational parameters
RANO interacts with SAS/CxM
Venue has up to 256 CBRS cells. All cells belong to one logical eNB
S1 interoperability is established between the shared eNB and the MNO EPCs
System supports inbound Cell Reselection & Session Continuity via NAS Service Request
System supports outbound Cell Reselection and S1 Handovers to each MNO
Description of RANO-MNO Coupling:
Event RANO—MNO Coupling:
Setup From MNO to RANO:
PLMN-ID, Macro EARFCN
S1 transport config. (MME IP&Port, Security-GW info)
From RANO to MNO:
eNB-ID, TAC
SAS/CxM interaction [nothing]
Intra venue mobility [nothing]
In/out mobility S1 signaling (if any)

Conclusions
Mobility between MNO RAN and Shared CBRS RAN:
IDLE Mode: Similar mobility as within MNO RAN.
CONNECTED Mode: Basic connected mode mobility (with transient idle mode state), is supported to both directions. It's also possible to generally support regular S1 based handovers for outbound mobility (from Shared CBRS RAN to MNO RAN) and in some cases also for inbound mobility (from MNO RAN to Shared CBRS RAN).

Local handling of mobility in shared RAN: Possible to deploy Shared CBRS RAN so that no S1 signaling toward MNO EPC is caused due to intra Shared CBRS RAN mobility. This can be achieved by deploying ‘large’ eNBs or heNB-GW.

Configuration of Shared CBRS RAN Parameters: To support Rel 14 and above UEs each MNO can configure the Shared CBRS RAN cells with its own TAC & Cell-ID. In cases where secondary MNO needs to serve also pre Rel 14 UEs via the Shared CBRS RAN, the secondary MNO needs to reuse the TAC and Cell-ID from the Primary MNO.

Requirement that SP has a PLMN-ID: MOCN based Shared CBRS RAN can be shared only among such SPs who have access to a PLMN-ID: These SPs may be existing MNOs, new entrants that choose to obtain a PLMN-ID and a Private Network SP utilizing CBRS-I as its PLMN-ID.

Limit of 6 PLMN-IDs in SIB1: A Shared CBRS RAN can support up to 6 PLMNs or a Private CBRS network/NHN together with up to 5 PLMNs.

Support for Private CBRS Networks: A Private CBRS Network can alternatively be deployed using the existing 3GPP EPS Architecture as discussed in Private Network Technical Report.

S1 based EPS architecture as specified in 3GPP Release 14, including MOCN based RAN sharing option, is usable as one possible architecture solution for neutral hosting and Private CBRS Networks. Use of this architecture allows the CBRS deployments to serve any 3GPP compliant band 48 supporting UE. The only authentication mechanism supported by 3GPP Release 14 is EPS-AKA which implies that non-SIM UEs will not be able to use this architecture.

Neutral Host Identifier Management

Introduction

In this disclosure, the SIB broadcasts are based on private network SHNI TAC-ID and Cell-ID. When the MNO UEs associates with the neutral host cell, the UE is provided MNO specific TAC-ID and Cell-ID in RRC connected mode.

The neutral host network populates its SIB parameters based on the OnGo Alliance identifiers purchased with the TAC-ID derived from the IBNs and the Cell-ID based the eNB-ID/gNB-IDs procured from OnGo Alliance. The neutral host cell apart from SHNI also populates the MNO PLMN-IDs in its SIB broadcasts.

When the MNO UE attaches to the neutral host, the UE's MNO association is learnt. Based on the MNO association, the TAC-ID and Cell-ID parameters are modified in RRC Connected mode based on the individual MNO authorized TAC-ID and Cell-ID. The MNO UE continues to use this MNO specific TAC-ID and Cell-ID while operating on a given neutral host cell.

The transitions across the macro network and neutral host network are discussed in the following sections.

UE Idle Mode Transitions from Macro to NH

The UE based on SIB broadcasts from the macro network or based on the out-of-service (OOS) scans, finds and transitions to the neutral host network.

Option A: Additionally in Connected mode during the Attach/RRC Configuration, UE obtains a TAI list when it attaches to an LTE network. This list shows the tracking areas where the LTE network believes a UE is located and within which a UE can travel without TAU. The neutral host network also includes the TAC-ID used in the SIB broadcast in the TAC-ID list to avoid the UE sending TAU upon Idle/Inactive transitions from one neutral host cell to another.
Upon transitioning to Idle mode/Inactive mode, the UE continues to use the TAC-ID and Cell-ID provided in connected mode to the UE. When the UE moves from one neutral host cell to another, the UE sees a change of TAC-ID in the new neutral host cell SIB broadcast and if this TAC-ID is present in the TAC-ID list provided to the UE, the UE does not initiate a TAU. The UE continues to use the TAC-ID provided to it in connected mode.
When the UE reenters connected mode, the neutral host network sense the MNO UE and provides the MNO authorized TAC-ID and Cell-ID to the UE.

Option B: As an alternative, the UE is not provided the TAC-ID list including the SIB broadcasted TAC-ID from neutral host cell.
With this option when the UE goes through idle HO, the UE will see a change in TAC-ID and will trigger the UE to send a TAU entering connected mode. The UE is provided the MNO authorized TAC-ID/Cell-ID while in connected mode.

To prevent the UE from sending Attach or TAU with the TAC-ID and Cell-ID from the SIB broadcasts, the neutral host network needs to ensure that these parameters are switched prior to the NAS signaling messages are exchanged.
UE provides the InitialUE-Identity and selectedPLMN-Identity is provided in
LTE RRCConnectionRequest/RRCConnectionSetupComplete [Ref 3GPP TS 36.331]
<S-TMSI>=<MMEC> <M-TMSI>; SAE Temporary Mobile Subscriber Identity; Locally identify a UE in short within a MME group (Unique within a MME Pool) [Ref 3GPP TS 23.003]
MMEC=MME Code; To identify an MME uniquely within an MME Group.
selectedPLMN-Identity: Index of the PLMN selected by the UE from the plmn-IdentityList included in SIB1.
5G NR RRCSetupRequest/RRCSetupComplete [Ref 3GPP TS 38.331]
<5G-S-TMSI>:=<AMF Set ID> <AMF Pointer> <5G-TMSI>[Ref 3GPP TS 23.003]
ng-5G-S-TMSI-Part1 (included in RRCSetupRequest): The rightmost 39-bits of 5G-S-TMSI. The 5G-S-TMSI is comprised of the AMF Set ID, AMF Pointer and 5G-TMSI.
ng-5G-S-TMSI-Part2 (included in RRCSetupComplete): The leftmost 9 bits of 5G-S-TMSI
selectedPLMN-Identity: Index of the PLMN or SNPN selected by the UE from the plmn-IdentityList or npn-IdentityInfoList fields included in SIB1.
The neutral host network is provisioned with the MNO/MVNO association with the MMEC identifier and the selected PLMN identity. There are two possible scenarios
First time attaching to a network (like a power on scenario)—in this case UE sends Random value as UE identity (there is no S-TMSI here) and a selected PLM N identity (this is picked from the list of PLMNs that eNB is broadcasting and is in the PLMN or EPLMN list stored on the SIM). Since we have separate S1 connection for each PLMN between eNB and MOCN, the MOCN gateway will pick the MNO based on this connection.
If the UE is re-attaching/going active from idle—in this case UE sends S-TMSI (which contains the MME code) as well as the selected PLMN identity which will identify the MNO network to use. Note that MOCN gateway will use the MME code to identify the MME in a pool (S1-Flex supported connectivity).
In summary, UE always communicates to eNB the PLMN identity that it selected to connect
The neutral host network sends the RRCConnectionReconfiguration providing the modified SIB1 parameters including the TAC-ID and Cell-ID associated with the MNO/MNVO
These are performed with SRB1 without allowing NAS messages to be forwarded to the packet core network until RRCConnectionReconfigurationComplete is received.
The NAS messages received from the UE after the RRCConnectionReconfigurationComplete are forwarded to the packet core.
eNB records the S-TMSI for which the TAC-ID and Cell-ID has been changed to the MNO identifiers. Subsequent connections, the reconfiguration procedures are not performed. When the UE moves out a given cell, this information is deleted so that when the UE reenters, this procedure can be run.

UE Idle Mode Transitions from NH to NH

The UE idle transitions from source NH cell to target NH cell in the enterprise campus is addressed in this section.

The UE is provisioned with the MNO TAC-ID when the UE was in connected on a NH cell on that enterprise campus. The UE may potentially may also be provided the SHNI TAC-ID as part of the TAI List provisioned from the MNO MME/AMF.

The UE remains in idle mode and uses the SHNI TAC-ID and Cell-ID from the SIB broadcasts. If the UE is provisioned with the SHNI TAC-ID in the TAI List, the UE will remain in idle mode when the UE transitions cells in idle mode. Otherwise, the UE will go into connected mode on the target cell and will be provisioned the MNO specific TAC-ID and Cell-ID to use on the target NH cell as described in section

When the UE goes into connected mode on target NH cell, the UE is provisioned with the MNO specific Cell-ID associated with the target of the NH Cell.

UE Connected Mode Transitions from Macro to NH

This section discusses the details of the UE transitioning from the macro network to the neutral host network.

When the UE transitions from one cell to another in connected mode, the target neutral host cell provides the updated set of MNO specific TAC-ID and Cell-ID parameters.

The UE is provisioned with the MNO specific TAC-ID and Cell-ID once the UE transitions into the NH cell.

UE Connected Mode transitions from NH to NH

This section discusses the details of the UE transitioning from a source NH cell to a target NH cell within an enterprise campus.

As part of the handover procedures, the RRCConnectionReconfiguration/RRCReconfiguration message carries the MNO specific TAC-ID and Cell-ID of the target NH cell.

Note that the handover procedures are handled within the enterprise network either as X2/Xn handover supported through interactions across eNB/gNB or as S1/NG handover supported through interactions across eNB/gNB and MOCN GW. In both mechanisms, the MNO core network is abstracted from the mobility procedures within the enterprise NH campus.

Note as well that the measurements of cells needs for the handover procedures are supported based on the SHNI based NH configurations and handled within the neutral host network.

Macro to Neutral Host Handover Scenarios

With the UE is subscribed to MNO-1 and UE is currently camped on the roaming network MNO-2. The UE transitions to the Neutral Host network.

MMEC identifier will point to the roaming partner MNO (MNO-2) rather than the home network (MNO-1) when UE transitions to the neutral host from a roaming partner MNO (MNO-2). Although this may not be typical with the USA MNO devices, it may have implications with preferred camping for international roaming agreements.
NHN supports only MNO-2
Expectation: It is fine to be on NHN operating with MNO-2 as long as there is no MNO-1 macro network coverage.
Solution: UE is on the most preferred network and no further steps are required.
NHN supports only MNO-1, but MNO-2 macro does not transition the UE to the MNO-2 NHN
Expectation: The UE is offloaded to NHN supporting MNO-1
Solution: UE performs HPPLMN scans to find the NHN and transitions to the NHN in idle mode. UE may be provisioned with geofence of the available NHNs and the UE used that to pro-actively transition to the NHN supporting MNO-1.
NHN supports both MNO-1 and MNO-2
Expectation: The UE should camp on the NHN, but with MNO-1 configuration and avoid roaming with MNO-2.
Solution: UE performs HPPLMN scans to find the NHN and transitions to the NHN in idle mode. UE may be provisioned with geofence of the available NHNs and the UE used that to pro-actively transition to the NHN supporting MNO-1.
NHN support MNO-2 and UE camped on MNO-1 macro poor coverage
Expectation: Given the poor indoor coverage for MNO-1 macro, UE will ping-pong between the MNO-2 NHN and MNO-1 macro network. The UE should prefer MNO-2 NHN until MNO-1 network coverage is stable.
Solution: The UE recognizing the ping-pong and fingerprinting the behavior for this site, prevents HPPLMN scans from returning the UE to MNO-1 macro network and leverage the MNO-2 NHN coverage. UE may be provisioned with geofence of the available NHNs and the UE used that to pro-actively transition to the NHN supporting MNO-2 for roaming purposes with the MNO-1 realizing poor coverage for their MNO-1 at that NHN location.

Private Network Behavior

The neutral host network populates its SIB parameters based on the OnGo Alliance identifiers purchased with the TAC-ID derived from the IBNs and the Cell-ID based the eNB-ID/gNB-IDs procured from OnGo Alliance. The neutral host cell apart from SHNI also populates the MNO PLMN-IDs in its SIB broadcasts.

When the MNO UE attaches to the neutral host, the UE's MNO association is learnt. Based on the MNO association, the TAC-ID and Cell-ID parameters are modified in RRC Connected mode based on the individual MNO authorized TAC-ID and Cell-ID. The UE continues to use this TAC-ID and Cell-ID while operating on a given neutral host cell.

Connected Mode HO

When the UE transitions from one cell to another in connected mode, the target cell provides the updated set of TAC-ID and Cell-ID parameters.

Idle Mode HO

Option A: Additionally in Connected mode during the Attach/RRC Configuration, UE obtains a TAI list when it attaches to an LTE network. This list shows the tracking areas where the LTE network believes a UE is located and within which a UE can travel without TAU. The neutral host network also includes the TAC-ID used in the SIB broadcast in the TAC-ID list to avoid the UE sending TAU upon Idle/Inactive transitions from one neutral host cell to another.

Upon transitioning to Idle mode/Inactive mode, the UE continues to use the TAC-ID and Cell-ID provided in connected mode to the UE. When the UE moves from one neutral host cell to another, the UE sees a change of TAC-ID in the new neutral host cell SIB broadcast and if this TAC-ID is present in the TAC-ID list provided to the UE, the UE does not initiate a TAU. The UE continues to use the TAC-ID provided to it in connected mode.

When the UE reenters connected mode, the neutral host network sense the MNO UE and provides the MNO authorized TAC-ID and Cell-ID to the UE.

Option B: As an alternative, the UE is not provided the TAC-ID list including the SIB broadcasted TAC-ID from neutral host cell.

With this option when the UE goes through idle HO, the UE will see a change in TAC-ID and will trigger the UE to send a TAU entering connected mode. The UE is provided the MNO authorized TAC-ID/Cell-ID while in connected mode,

Aspects to Address

The above information needs to be ratified with all the MNOs and MSOs.

Single TAC-ID within a region will impact UE camping on neighboring private networks. The current procedures provide isolation of private network by using distinct TAC-IDs and private networks providing reject code of #15 to prevent UE reentering a private network where the UE does not have valid credentials.

The Cell-ID range of 5000 is provided. With country wide deployments of neutral hosts, this will not allow for uniquely resolving Cell-IDs within the MNO cores.

In some embodiments, there is a desire to understand if the Cell-ID needs to be unique within an MNO or can be interpreted together with PLMN-ID and/or TAC-ID and how the measurement reports are handled in the MNO core for location determination.

Identifier Issues Related to Attach Procedure for PCNN UE

In some embodiments, when a UE 212 attempts to camp on an eNB/gNB 208 of a PCNN 202, the UE 212 includes information indicating the “last visited registered TAI” in an attach request message. The last visited registered TAI information indicates the PCNN TAI that was associated with the eNB upon which the UE was last camped. When the MNO network core 214 receives the attempt by the UE 212 to register with the MNO network core 214, the MNO network core 214 (and in particular, an MME within the MNO network core 214) can either interact with the PCNN 202 to retrieve the prior context of the UE 212, or the MNO network core 214 can elect to ignore the previous context and re-establish the full UE context again. In some embodiments, for the MNO network to use the last visited registered TAI, the PCNN TAI is mapped to the MNO TAI. In some embodiments, this mapping is done by the TMD 210 within the PCNN 202. In other embodiments, this mapping is established by the IDM 220 within a Public Neutral Host Identifier Mapping System (NIMS) in the MNO network core 214. The NIMS service is supported on the PCNN 202 by the IDM 210 within the Non-Public NIMS to provide the PCNN-deployed TAIs and Cell-IDs to the MNO NIMS 310. In turn, the IDM 220 within the Public MNO NIMS receives the information from IDM 210 within the Non-Public network NIMS and provides the mapping from the PCNN TAIs to the MNO TAIs and from the PCNN Cell-IDs to the MNO Cell-IDs.

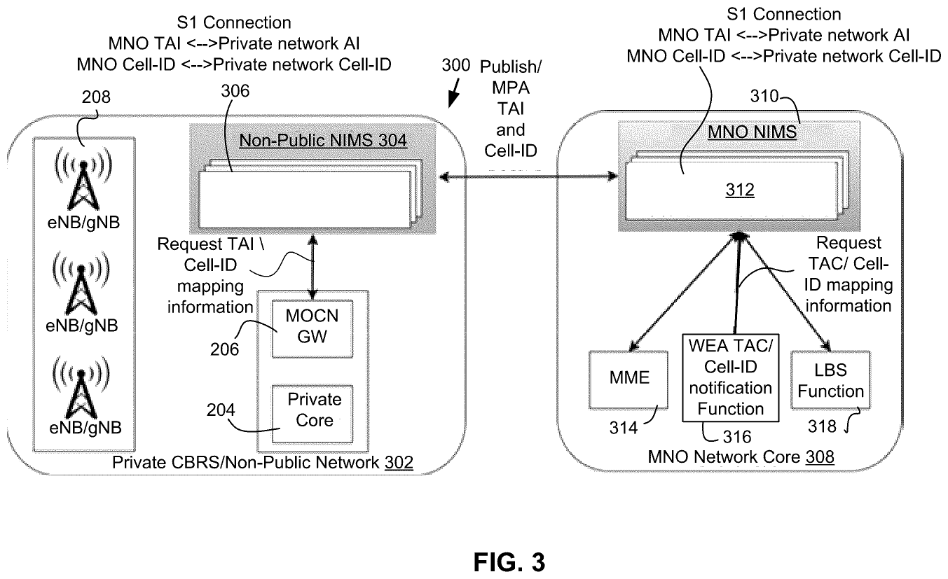

The identifier mapping is performed on a basis of a per S1 connection between the PCNN 202 and the MNO network core 214 (see FIG. 3). The information exchanged between the PCNN NIMS and MNO NIMS is interpreted within the context of an S1 connection.

Given that multiple entities in the PCNN 202 and the MNO network core 214 require the identifier mapping information, in some embodiments, an independent service can be hosted in an appropriate entity having the necessary capability.

MNO Obtains a Semi-Independent PLMN-ID for Enterprise Neutral Host Operation

In some embodiment, each MNO obtains a semi-independent PLMN-ID for enterprise neutral host operation.

The enterprise network supporting neutral host is deployed with the TAC and Cell-ID associated with the SHNI. This information is provided to the MNOs. The expectation is that these TACs and Cell-IDs are unique within each of the MNOs PLMNs used by the UE to camp on the neutral host network.

This MNO identified PLMN for neutral host is populated in the SIM credential PLMN list for the UE to camp on the enterprise network. The relative prioritization of this MNO identified PLMN for neutral host camping can be specified in the PLMN list. Additionally, radio procedures for transitioning from the macro network to the enterprise network can be coordinated based on SIB broadcasts from the macro network.

Current TAC and Cell-ID Assignment Procedures from CBRS

There are 6 TAC per IBN purchased assigned. There are 10K IBNs, resulting in 60K TACs that can be associated with the IBN purchases. TAC is a 16-bit identifier. 2\hat{ }16-60K=5536 can be “locally” allocated and independently purchased from OnGoA.

The Cell-ID are individual purchased and associated with the SHNI to form the ECGI.

Aspects to Address

Initial input is not received is some embodiments. In such embodiments, this is ratified with all the MNOs and MSOs.

In some embodiments, a semi-independent PLMN can be accommodated for NHN in the MNO cores together with a larger space of TAC-ID/Cell-ID supported.

Handling of TAI List in PCNN

In response to receipt of the last visited registered TAI within the MNO network core 214, the MNO network core 214 (and in some embodiments, the MME within the MNO network core 214) provides a TAI list (i.e., a list of tracking areas identified by TAIs) to which the UE 212 can transition without the need to send a Tracking Area Update (TAU) message. The TAIs within the list are mapped to PCNN TAIs either by the IMD 210 within the MNO network core 214 or the IMD 210 within the PCNN 202.

In some embodiments, the MNO network core 214 does not provide a TAI list in response to receiving the last visited registered TAI. That is, since PCNNs are typically small enough that all of the eNB s/gNB s within the PCNN may be held within the same TAI, or within a group of TAIs that are sufficiently related to one another that no TAU is necessary, it can be assumed that there is no need for a TAI list. The size of the PCNN also limits the paging area for the UE. It should be noted that when one or more active sessions are to be transitioned from the PCNN 202 to the MNO core network 216, the prior UE context is retrieved to establish real-time services, such as voice over LTE (VoLTE).

E-911 Calls from PCNN UE

Unlike the case in which a UE 104 is communicating through an MNO eNB/gNB 114, when a UE 212 is communicating through an eNB 208 that is part of a PCNN 202 (i.e., a PCNN UE), the MNO network does not have access to the PCNN Cell-ID and the PCNN TAI of the PCNN eNB 208. Rather, the MNO assigns an MNO Cell-ID and an MNO TAI to the MOCN gateway 206. The MOCN gateway 206 is then responsible for determining which of the PCNN eNBs/gNBs 208 to send the communication stream to, based on the International Mobile Subscriber Identity (IMSI) of the PCNN UE 212 to which the communication is being directed. Furthermore, when a PCNN UE 212 makes an E-911 call, the position location information provided by the PCNN UE 212 in response to the request from the E-SMLC in the MNO core 214 will include PCNN Cell-IDs and PCNN TAIs for which the MNO network has no knowledge (and in particular, no position location information from which to determine the location of the PCNN UE 212). The IMD 210 provides a means by which the MNO network 202 can map the PCNN Cell-ID and PCNN TAI to an MNO Cell-ID and MNO TAI for which the MNO will have position location information. This information can then be provided to a PSAP 226.

In some embodiments of the disclosed method and apparatus, the IMD 220 is located within the E-SMLC 222. Locating the IMD 220 in the E-SMLC 222 allows the operation of the disclosed method and apparatus with the least impact on a standard LTE architecture, as defined by 3GPP standards. In some embodiments, an IMD 210 may also be located within the PCNN 202. Accordingly, any Cell-IDs and TAIs can be mapped within the PCNN 202. In some embodiments, the IMD 220 in the MNO network core 214 is capable of mapping local PCNN Cell-IDs and TAIs, for several different PCNNs 202, to the MNO Cell-IDs and TAIs. In some embodiments, mappings are maintained based on S1 connectivity established with the MOCN gateways 206 for each PCNN 202. In some embodiments, the same MOCN gateway 206 is capable of communicating with more than one PCNN 202 (note that only one is shown for the sake of simplicity).

Request for Commercial Location Based Services from PCNN UE

Similar to the case in which a PCNN UE 212 makes an E-911 call, when a PCNN UE 212 attempts to access position location services, the PCNN UE 212 provides position location information that the MNO uses to determine the position of the PCNN UE 212. Accordingly, for servicing requests for commercial LBS from the PCNN UE 212, the same type of IMD database look-up and mapping (as the identifier mapping described above) maps the PCNN Cell-IDs and TAIs (if appropriate for the particular type of position location services) to MNO Cell-IDs and TAIs. Based on this mapping, the MNO E-SMLC 222 can determine the location of the PCNN UE 212 and provide that location to a commercial LCS client 228.

It can be seen from the above description that the Location Based Service (LBS) procedures are initiated from the MNO core 214, via LBS function 224. However, such LBS procedures depend on PCNN identifiers for Radio Access Technology (RAT) dependent measurements in order for the PCNN UE 212 to report position location information. The MNO core 214 issues these requests to the UE 212, based on the PCNN identifiers, by mapping from the MNO identifiers to the PCNN identifiers. Accordingly, for LPPa and New Radio Position Protocol A (NRPPa) procedures, the PCNN 202 performs the required translations to the MNO network identifiers to report the information to the MNO core 214.

### Emergency Messages Sent Through the Public Warning System (PWS) to PCNN UEs

In some embodiments in which a PWS message is sent to PCNN UEs 212, the IMD 210 is located either within the MOCN gateway 206 or relatively tightly coupled to the MOCN gateway 206. In either case, by having the IMD 210 located within the PCNN 202, the impact on standard MNO networks to which the PCNN UEs interact is minimized. In some embodiments, an IMD 220 is also located within the MNO core 214.

When the LCS client 228 is the Wireless Emergency Alert (WEA) Notification Provider 230 attempting to send a PWS notification message, the notification is sent to an MNO Cell-ID and MNO TAI together with the notification area information. The MOCN gateway 206 then uses an IMD 210 to map to those of the PCNN Cell-IDs and the PCNN TAIs that are within the notification area.

### Alternatives

In some embodiments in which it is difficult or undesirable to map PCNN Cell-IDs and PCNN TAIs to MNO Cell-IDs and MNO TAIs (and in other cases), the following alternative schemes may be implemented in accordance with the disclosed method and apparatus.

### PCNN Direct Connectivity to WEA Notification Providers

In some embodiments, the PCNN network 302 obtains emergency alerts and supports the broadcasts independently. To support the broadcasts independently, the APs 208 to which the broadcast needs to be sent are determined based on the notification area(s) indicated in the message. MNO-initiated WEAs do not need to be processed because the PCNN 302 handles the WEAs independently.

WEAs Forwarded to the PCNN from the MNO

The expectation is that the WEAs received from the Notification Provider 230 are forwarded to the PCNN 202 from the MNO include information regarding the notification area where the message needs to be delivered. One or more regions where PCNN sites/APs are located and where the information needs to be broadcasted are determined by having the PCNN 202 match the cell sites to the required notification areas.

The PCNN 202 uses the WEAs provided by only one of the MNOs. The choice of the MNO is based on the specific regions based on the WEAs routed to the PCNN 202 and on where neutral hosts are deployed that are associated with specific MNOs. The target UE is identified based on the MNO chosen, as described in the next section.

### PCNN Matching Cell Sites to Required Notification Areas

The WEAs received from the Notification Provider 230 are forwarded to the PCNN 202 from the MNO. The WEAs include the notification area where the message needs to be delivered. The PCNN sites/APs, etc., to which the information needs to be broadcasted, are determined by the PCNN 202 matching the cell sites to the required notification area.

The received WEAs are delivered as a broadcast after removing duplicates across MNOs by comparing the contents and combining the required area of delivery based on the notifications received from the individual MNO cores.

In some embodiments, each MNO obtains a PLMN-ID for enterprise-neutral host operations. The enterprise network supporting the neutral host is deployed with a Timing Advance Command (TAC) and Cell-ID associated with a Shared Host Neutral Identity (SHNI) (the EUTRAN Cell Global Identifier (ECGI) is a combination of the SHNI and the Cell-ID, and the TAI is a combination of the TAC and the SHNI). The UE adjusts its transmission timing when a TAC is received.

The TAC and Cell-ID are provided to the MNOs. The TACs and Cell-IDs associated with a PLMN are unique within that PLMN. The TAC indicates the change of the uplink timing relative to the current uplink timing and the time it takes the radio wave to reach the UE. The distance to the UE and therefore the location of the UE can be determined from the TAC. The Cell-IDs are used for routing messages via the neutral host network to the UEs.

A network device associated with the neutral host or the PLMN stores a list of Subscriber Identity Module (SIM) credentials associated with a neutral host so that the UE can receive and send messages on the enterprise network. The relative prioritization of this PLMN (identified by the MNO) for the usage of the neutral host can be specified in the PLMN list. Additionally, radio procedures for transitioning from the macro network to the enterprise network can be coordinated based on System Information Broadcasts (SIB) from the macro network.

### S6a/S8 Based Neutral Host Architecture

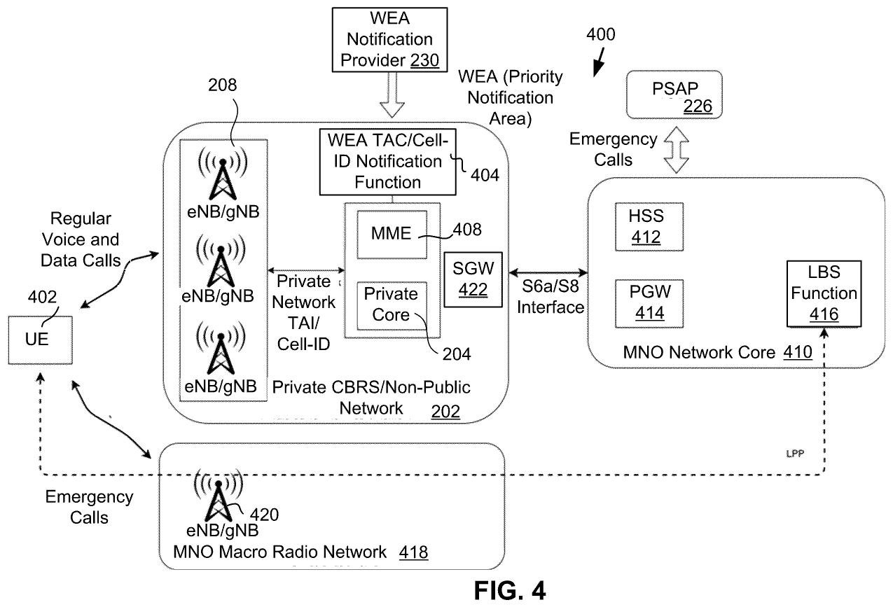

FIG. 4 illustrates an S6a/S8-based neutral host architecture 400. In neutral host A\architecture 400, UE 402 places regular voice calls using PCNN 202. PCNN 202 includes APs 208, which connects, via private-network TAI and cell ID, with a private network having the private core 204, the MME 408 and SGW 422. PCNN 402 is connected, via an S6a/S8 interface, to MNO Network Core 410. MNO Network Core 410 includes HSS 412, PGW 414, and LBS Function 416. Neutral host Architecture 400 also includes MNO macro network 418, which has AP 420. Neutral host Architecture 400 also includes PSAP 418 and WEA notification provider 422. PSAP 418 interacts with MNO network core 410, facilitating emergency communications. WEA notification provider 230 sends WEA notification to PCNN 202. Emergency calls are sent, via MNO macro radio network 418, AP 420, MNO Network Core 410 and LBS function 416.

In the embodiments associated with FIG. 4, a roaming connection is established, via the S6a/S8 interface, between PCNN 202 (i.e., the enterprise network) and the MNO network core 410. In some embodiments, the S6a/S8 interface may be replaced with any interface for roaming interface. The S6a interface (between PCNN 202/MME 408 and MNO Network Core 410/HSS 412) enables the transfer of subscription and authentication data. The S8 interface (between the SGW 422—within private core 204—and the PGW 414) provides an Inter-PLMN reference point with a user plane and control plane between the SGW and the PGW 414.

Referring to FIG. 4, in some embodiments, the MME 408 and SGW 422 are housed in the enterprise network (PCNN 202), providing support for CMAS/ETWS, which are managed independently by the PCNN 202 without the support of MNO Network Core 410. Also, emergency calling is disabled in the enterprise network/PCNN 202, and instead of using the emergency calling of the PCNN 202, the UE 402 finds an available MNO macro network 418 to place the emergency call.

S6a/S8 Based Neutral Host Architecture without an MNO Macro Network

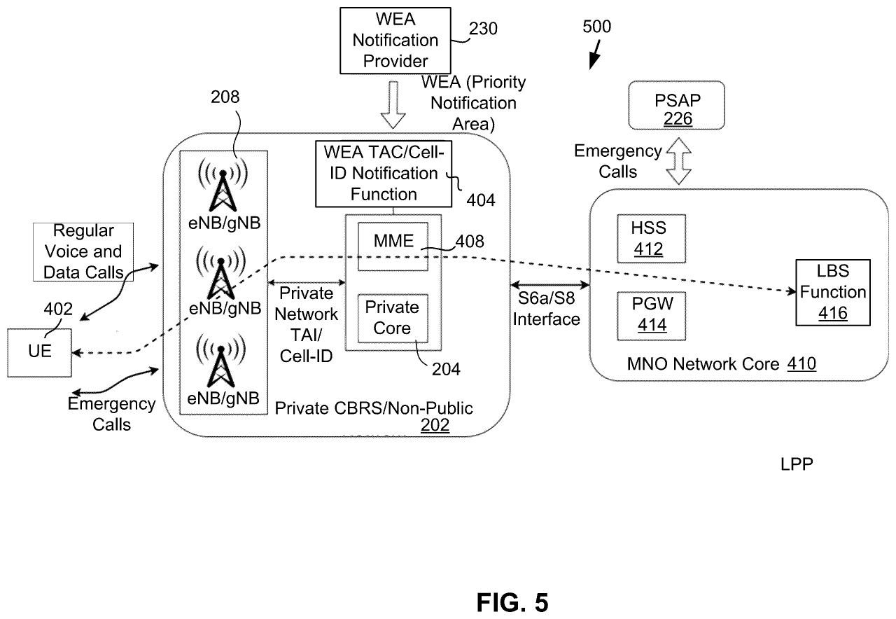

FIG. 5 illustrates an S6a/S8-based neutral host Architecture 500 that does not use an MNO macro network. In the embodiment of FIG. 5, emergency calls are also supported on the enterprise network (in contrast to the embodiments of FIG. 4), and the UE 402 sends emergency calls to PCNN 202. The LPP protocol uses the control plane and routes the messages through the MME 408 of the PCNN 202. The MME 408 maps the MNO-network-assigned-Cell-ID to the enterprise-assigned-Cell-ID when forwarding the message to the UE 402. When the UE 404 reports the measurement information, the MME 408 receives the measurement information. At the MME 408, the PCNN Cell-ID is converted to the MNO Cell-ID before forwarding the information to the MNO network core 410. Using the neutral host Architecture 400 and 500, the MNO Network Core 410 and the MNO Network do not need to be altered.

S6a/S8 based Neutral Host Architecture with Private Host and IMSI Server

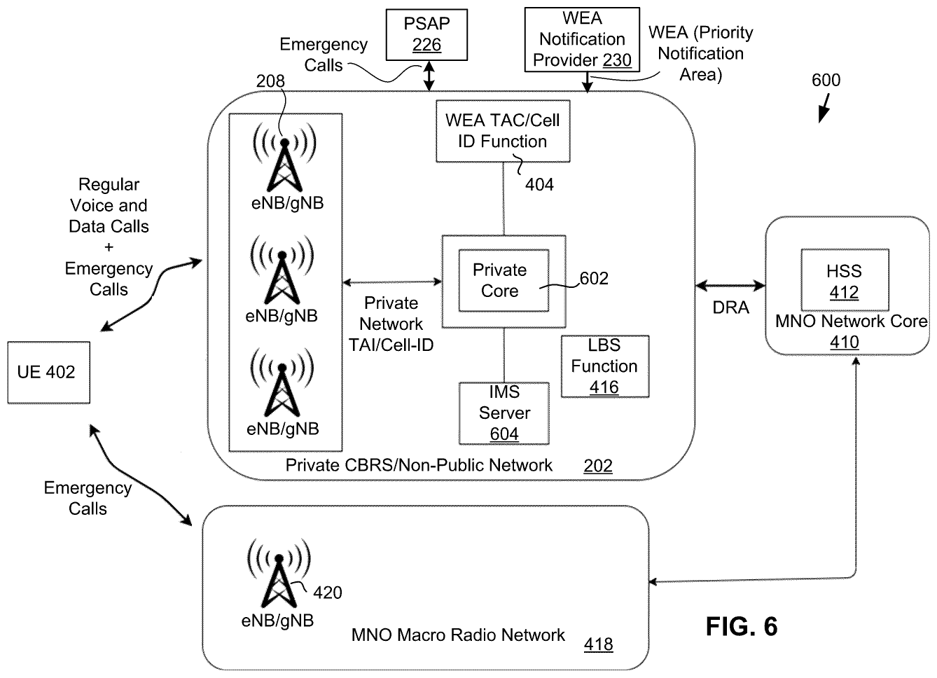

FIG. 6 illustrates an S6a/S8-based neutral host Architecture 600. Neutral host Architecture 600 is similar to neutral host architecture 400 of FIG. 4. However, neutral host architecture 600 has private host 602 and IMS server 604. Also, LBS function 416 is located in PCNN 202. The PCNN 202 has a Diameter Routing Agency (DRA) connection with MNO network core 410. The DRA may also be referred to as a Diameter Signaling Controller (DSC).

The UE 402 places regular voice calls using the PCNN 202. PCNN 202 includes APs 208, which connects, via private-network TAI and cell ID, with a private network having the private core 204 and the MME 408. PCNN 402 is connected, via an S6a/S8 interface, to MNO Network Core 410. MNO Network Core 410 includes HSS 412, PGW 414, and LBS Function 416. Neutral host architecture 600 also includes MNO macro network 418, which has AP 420. Neutral host architecture 600 also includes PSAP 418 and WEA notification provider 422. PSAP 418 interacts with MNO network core 410, facilitating emergency communications. WEA notification provider 230 sends WEA notification to PCNN 202. Emergency calls are sent, via MNO macro radio network 418, AP 420, MNO Network Core 410 and LBS function 416.

In the embodiment of FIG. 6, PCNN 202 (or another enterprise network) is treated as a roaming partner. In the embodiment of FIG. 6, the UEs camped on PCNN 202 need to support IMS voice/video calling to receive the WEA. The IMS-based service is deployed, via IMS server 604, on the enterprise campus along with the authentication required for the UE 402 to connect to the Proxy Call Session Control Function (P-CSCF).

The UE 402 is authenticated with the HSS 412, via a DRA. In some embodiments, the DRA of FIG. 6 enables a Policy and Charging Rules Function (PCRF) discovery and selection as part of a Policy Charging and Control (PCC) architecture. IN some embodiments, if multiple PCRFs are available, the DRA ensures an appropriate PCRF is initially selected and subsequently ensures that this PCRF is used for future transactions associated with the subscriber. In some embodiments, the DRA routes of Diameter messages.

Connectivity to the WEA notification provider 230 is supported, for sending a WEA, within PCNN 202, via WEA TAC/cell-ID notification function 404.

The UE 402 leaves the PCNN 202 (or another enterprise network) to find a macro network for enabling emergency calling. The embodiment of FIG. 6 enables emergency calling together with LBS service (via LBS function 416) on the campus of PCNN 202.

In some embodiments, each MNO obtains a PLMN-ID for enterprise-neutral host operations. In some embodiments, the enterprise network supporting the neutral host is deployed with the TAC and Cell-ID associated with the SHNI, and this information is provided to the MNOs. The expectation is that these TACs and Cell-IDs are unique within each MNO PLMN used by the UE to camp on the neutral host network.

This MNO-identified PLMN for a neutral host is populated in the SIM credential PLMN list for the UE to camp on the enterprise network. The relative prioritization of this MNO-identified PLMN for neutral host camping can be specified in the PLMN list. Additionally, radio procedures for transitioning from the macro network 418 to the PCNN 202 can be coordinated based on SIB broadcasts from the macro network 418.

In some embodiments, eNB-IDs/gNB-IDs are individually purchased and associated with the SHNI to form the E-UTRAN Cell Global Identifier (ECGI). The ECGI is a global identifier. In some embodiments, the ECGI includes an MCC (Mobile Country Code), MNC (Mobile Network Code) and the ECI (E-UTRAN Cell Identifier).

Introduction

This section summarizes CBRS RAN Sharing (CBRS MOCN) for Neutral Hosting.

### Definitions and Abbreviations

### Abbreviation

3GPP 3rd Generation Partnership project
ANR Automatic Neighbor Relation
API Application Programming Interface
CB SD Citizens Broadband radio Service Device
CGI Cell Global Identifier
CxM Coexistence Manager
EARFCN E-UTRA Absolute Radio Frequency Channel Number
ECGI E-UTRAN Cell Global Identifier
EPC Evolved Packet Core
HeNB-GW Home eNB Gateway
LTO Local Traffic Offload
MNO Mobile Network Operator
MOCN Multi Operator Core Network
MVNO Mobile Virtual Network Operator
NAS Non Access Stratum
NHN Neutral Host Network
OAM Operations, Administration and Management
PCI Physical Cell Identity
PDN Packet Data Network
PLMN Public Land Mobile Network
RAN Radio Access Network
RAT Radio Access Type
RRC Radio Resource Control
SAS Spectrum Access System
SIB System Information Block
TAC Tracking Area Code
UE User Equipment

Baseline Mobility Model

Overview

Mobility for the CBRS MOCN for Neutral Hosting solution is based on 3GPP EPS specifications TS23.401, TS36.331, TS36.304 and other associated specifications. The assumed use of 3GPP specified mobility procedures are described in the following sections.

Mobility within a Shared CBRS RAN

Full 3GPP mobility can be supported between cells within a Shared CBRS RAN. This includes idle mode cell reselection and connected mode X2/S1 handovers. Handovers are possible as eNBs within CBRS RAN are assumed to be aware of the current EARFCNs utilized within the Shared CBRS RAN and thus Shared CBRS RAN is able to facilitate appropriate UE measurements. If specific CBSD eNBs are forced to change EARFCN due to SAS actions, the neighbor Shared CBRS RAN eNBs within the same Shared CBRS RAN can be informed about the change e.g. using X2 ENB CONFIGURATION UPDATE or OAM coordination.

Inbound Mobility from Other RANs to Shared CBRS RAN

This section assumes single-radio UEs of Type 1.

Basic Idle Mode Inbound Mobility

In case the Service Provider supports also other RANs, inbound mobility to Shared CBRS RAN can be achieved based on UE driven IDLE mode Cell Reselection. When UE is camped on other RAN or when UE loses other RAN coverage, UE may be configured to proactively look for available CBRS RAN cells and upon finding a suitable cell, UE may perform cell re-selection to such Shared CBRS RAN cell.

Basic Connected Mode Inbound Mobility

A basic level of Connected mode inbound mobility can be achieved via RRC Connected->RRC Idle->RRC Connected transition upon UE losing other RAN coverage and by UE performing a NAS Service Request to reconnect the PDN connections via the Shared CBRS RAN. The performance can be acceptable if the UE connects to the target side before the UE context is cleared via the source side. Whether a Shared CBRS RAN can be discovered within such an acceptable time period depends on UE's algorithms for scanning for Band 48 cells. This limitation is similar as which applies for inbound mobility from MNO to a S2a based NHN.

Enhanced Inbound Mobility

A Service Provider may be aware of the frequencies used by Shared CBRS RAN s in a given area. For example, the frequency information (e.g EARFCNs & operating channel bandwidth) may be dynamically discovered by the Service Provider from:

Deploying ANR function, defined by 3GPP 32.511, where a fraction of UEs are ordered to search for potential Shared CBRS RAN EARFCNs and cells

Information acquired from the organization operating the Shared CBRS RAN s

Received S1 handover signaling from such Shared CBRS RAN s (S1 Handover signaling from source eNB to target eNB carries the source eNB EARFCN)

When Service Provider is aware of EARFCNs on which Shared CBRS RAN s may operate, the Service Provider can improve the inbound mobility performance in different ways:

Configure its UEs to search for Shared CBRS RAN cells on these known frequencies while UE is still within the other RAN coverage by providing the UE with appropriate inter frequency scanning configuration via regular SIB s (primarily SIB 5) or via dedicated signaling.

Configure its UEs to perform measurements on these known EARFCNs and, upon receiving measurement reports, initiate rrcConnectionRelease with RedirectedCarrierInfo (if single EARFCN) or IdleModeMobilityControlInfo (if several possible target EARFCNs). ReleaseCause should be ‘other’ or ‘rrc-Suspend-v1320’.

Configure its UEs to perform measurements on these known EARFCNs and, upon receiving measurement reports, also initiate regular inbound S1 handovers towards those Shared CBRS RAN s. If MNO RAN does not hold the mapping PCI□CGI for Shared CBRS RAN cells (PCI values may e.g. not be locally unique), then MNO RAN can order the UE to reportCGI for the discovered cells on these EARFCNs.

In order to minimize the MNO intra-network performance impact, measurement on Shared CBRS RAN EARFCNs can be done by configuring reducedMeasPerformance-r12.

Outbound mobility to other RANs from Shared CBRS RAN

This section assumes single-radio UEs of Type 1. It is also assumed that the Shared CBRS RAN is configured with the EARFCNs of at least one neighboring MNO EARFCN for each of the supported PLMNs.

Idle Mode Outbound Mobility

In case the Service Provider supports also other RANs, outbound mobility from Shared CBRS RAN to other RANs can be achieved based on UE driven IDLE mode Cell Reselection. When UE is in IDLE state at Shared CBRS RAN or enters IDLE state due to loss of RRC connection at Shared CBRS RAN, UE reselects an available other cell as specified in 3GPP TS 36.304 and TS 36.331. The loss of RRC Connection at Shared CBRS RAN may be triggered e.g. by an actual loss of radio coverage or by reception of RRC Connection Release with or without redirection info.

The EARFCNs primarily searched by the UE are informed to the UE in dedicated signaling (idleModeMobilityControlInfo), if provided, or otherwise in regular Shared CBRS RAN SIB s (primarily SIB 5).

Connected Mode Outbound Mobility

A basic level of Connected mode outbound mobility does not require knowledge of any neighboring MNO EARFCNs. Basic connected mode outbound mobility can be achieved via RRC Connected->RRC Idle->RRC Connected transition with UE performing a NAS Service Request to reconnect the PDN connections via the other RAN.

When Shared CBRS RAN provider is aware of EARFCNs on which MNO RANs operate, the Shared CBRS RAN provider can improve the outbound connected mode mobility performance for supported PLMN UEs in different ways:

Configure MNO UEs to perform measurements on those other EARFCNs and, upon receiving measurement reports, initiate rrcConnectionRelease with RedirectedCarrierInfo (if single EARFCN) or IdleModeMobilityControlInfo (if several possible target EARFCNs). ReleaseCause should be ‘other’ or ‘rrc-Suspend-v1320’.

Configure MNO UEs to perform measurements on those EARFCNs and, upon receiving measurement reports, also initiate regular outbound S1 handovers towards those MNO RANs.

The MNO frequency information (EARFCNs) may be dynamically discovered, for example from:

Received handover related S1 (S1 Handover signaling from source eNB to target eNB carry the source eNB EARFCN)

Information Acquired from the Participating MNOs

Deploying an ANR function, where a fraction of UEs are ordered to search for potential MNO EARFCNs and cells

Mobility to and from NHN S2a Architecture

The same mobility model as described for NHN S2a architecture in Release 1 applies:

Mobility from Shared CBRS RAN to NHN S2a happens as described in Release 1 for NHN inbound mobility. The procedures are the same regardless whether the source RAN is a shared RAN or single PLMN RAN.

Mobility from NHN S2a to Shared CBRS RAN happens as described in Release 1 for NHN outbound mobility. The procedures are the same regardless whether the target RAN is a shared RAN or single PLMN RAN.

Specific Feasibility Study Items

Local handling of intra Shared CBRS RAN mobility

In this study item different options to handle mobility within a Shared CBRS RAN network are explored.

Option 1: Direct S1 Interfaces

In this option an eNBs in a Shared CBRS RAN is handled as an eNB in a PLMN network i.e., with one S1 instance to each participating PLMN EPC. Intra Shared CBRS RAN Mobility between eNBs will in this option always be handled by the PLMN EPC same as the participating PLMN deployed the eNB themselves.

A variant to this option is to deploy “large” eNBs capable of handling many CBRS cells. One eNB can handle up to 256 cells according to 3GPP specifications. I.e., in this deployment option, one S1 connection can handle 256 shared CBRS cells and no signaling is done over S1 when UE moves between cells handled by the same eNB. This is already today supported by many RAN systems for traditional LTE bands. Then the single eNB have multiple LTE cells that can physically be deployed throughout a geographical area.

Note: There is an option to send cell identifier to PLMN MME at intra-eNB mobility but this is typically not done in current PLMN deployments since it causes high signaling load.

Note: MNOs and Shared CBRS RAN providers can be expected to typically operate in separate IP address domains. The Shared CBRS RAN is however assumed to be capable of using MNOs IP ranges in its S1 interface termination, each S1 instance being isolated from each other to avoid need for any IP address coordination between MNOs. It is assumed that no X2 is established between MNOs and Shared CBRS RAN provider, in order to simplify the network and product design.

Option 2: S1 Aggregation Via HeNB GWs

In this option the Shared CBRS RAN S1 connections are aggregated in one or a few HeNB GWs. The HeNB GW have S1-C and S1-U connections to the local eNBs (where each eNB represents one or multiple CBSDs) and then the gateway only has one S1 connection to each participating PLMN EPC. Mobility between eNBs handled by one HeNB GW is handled locally and is completely hidden from PLMN EPC.

In this solution the PLMN EPC will only see one S1 connection per HeNB GW in the Shared CBRS RAN network. Specification impact is FFS.

Note: S1 interface probably needs IPsec and Firewall protection. It may be operationally simpler to use a HeNB GW to reduce the number of Shared RAN to MNO S1 links, although the number of eNB↔HeNB-GW interfaces is high, but now handled within the Shared RAN organization.

Both options 1 and 2 are 3GPP compliant and it is a deployment choice which options are to be used in given deployment instance.

Configuration of Shared CBRS RAN Parameters

General

Parameters for the Shared CBRS RAN are configured by the entity that operates the Shared CBRS RAN. These parameters include system info broadcast parameters, eNB operational parameters and parameters related to interaction with SAS/CxM.

Coordinated PLMNs and Cell Access Info

PLMNs sharing a CBRS RAN may decide to coordinate Cell Access Info for the Shared CBRS RAN among themselves. For these PLMNs coordinated Cell Access Info is broadcasted in SIB1. This Cell Access Info includes:

PLMN-ID list: The Primary PLMN-ID and optionally up to 5 Secondary PLMN-IDs

Cell-ID

Tracking Area Code (TAC)

Cell-ID: RRC and S1 signaling use the ECGI format for identifying cells {ECGI=Primary PLMN-ID+Cell-ID}. ECGIs are globally unique without any coordination between PLMNs. Secondary PLMNs need to just handle ECGI values which contain a PLMN-ID different from their PLMN-ID. Coordination of the Cell-ID applies also between CBRS-I and other PLMN-IDs.

TAC: NAS and S1 signaling use the TAI format for identifying tracking areas {TAI=Selected PLMN+TAC}. As UEs have different Selected PLMNs, the TAC values for the Shared CBRS RAN cells need to be chosen so that they do not conflict with TAC values being used in the same area by any of the sharing PLMNs. There is 65′536 TAC values.

Example TAC coordination approach: Each PLMN interested to share some of its CBRS RAN deployments, carves out a small range of TACs (e.g. 250 TACs), which it will use for its CBRS RANs available for sharing with other PLMNs. This carved out range is informed to other PLMNs. Other PLMNs interested in becoming CBRS RAN sharing partners with the deploying PLMN will stop using the carved out range in its own RAN deployments. Deploying PLMN can assign any TAC value from this carved out range to its CBRS RAN deployment according to its own TAC planning mechanisms and these TAC values will not conflict with the values used by any of the other PLMNs.

Example with 4 PLMNs: PLMN A carves out e.g. values 61′001-61′250, PLMN B: 61′251-61′500, PLMN C: 11′001-11′200 and PLMN D: 34′251-34′300.

Implications for Neutral Host

The TAIs and Cell-IDs (LTE: 20-bit+8-bit) (NR: 36-bits) are specific to Private/Non-Public campus deployments and typically involves a translation of these identifiers for establishing connectivity to the MNO core and exchange signal and user plane traffic. The translation is specific to each MNO.

Current procedure involves the MNO core determining the TAIs and Cell-IDs based on the required notification area to deliver the WEA/PWS messages and location algorithms based on measurement reports of Cell-IDs.

This approach will no longer work given the aggregation of the campus sites involved with the MOCN GW.

The Below Aspects Need to be Addressed

UE includes the ‘Last Visited Registered TAI’ in the Attach Request message. The UE when it previously Attached to a Private CBRS/Non-Public network, it will provide the Private CBRS/Non-Public network TAI.

The MNO MME in the Attach Accept message may provide a TAI List providing the tracking areas where the UE can transition without sending a TAU Update. The TAI List needs to match the TAIs deployed by the Private CBRS/Non-Public network.

For WEA/PWS, each MNO that the Private/Non-Public campus is associated with as a NH (neutral host) will provide the alerts. These will potentially have duplicates based on the associated MNO(s) for NH and only one copy of the message needs to be delivered as broadcast on the Private/Non-Public network.

For LBS, the procedures requires knowledge of the deployed eNB-ID identifiers at that MNO core to request the UE/Private/Non-Public network to perform measurements reporting to enable horizontal and vertical positioning.

Given the MOCN GW aggregates the traffic for multiple Private/Non-Public sites and potentially multiple Private/Non-Public networks, this will require the notification area for WEA and trilateration procedures for LBS cannot be determined based on the MNO TAI/Cell-ID implicitly based on what is used for operations on the MOCN GW—MNO core interconnect.

Proposed Solution(s)

Proposal 1

The MNOs all align to use the same TAC-ID and Cell-ID for each neutral host deployment.

TAC-ID

The recommendation for the TAC can be to specify the “high byte” to use a specific value with the freedom for the individual neutral host deployments to use any of the 256 “low byte”.

For LTE and the currently available devices in the market for 5G NR don't support independent TACs per PLMN in the SIB broadcasts and a single value needs to be used for all devices camping on the neutral host cell.

The support for per-PLMN TAC support feature can be introduced in the 5G NR neutral host networks but will require backward compatibility until the legacy devices are sunset. Once per-PLMN TAC-ID can be supported, this aspect becomes a non-issue.

Cell-ID

The Cell-IDs need to be uniquely assigned and when interpretable in the individual MNO cores and enterprise network.

Note: The Cell-Id needs to be unique within a PLMN-ID. This is independent of the TAC-ID of the cell given that the LBS procedures require measurements and UEs only report the Cell-ID as part of the measurement reports.

Identifier assignments provided from MNO

TAC-ID

High Byte=0xDE

Low Byte=A single assignment based on FCC economic area

Although the disclosed method and apparatus is described above in terms of various examples of embodiments and implementations, it should be understood that the particular features, aspects and functionality described in one or more of the individual embodiments are not limited in their applicability to the particular embodiment with which they are described. Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
determining, based on a location component, one or more particular UEs (User Equipment) that are communicating via a private network; and
directing an emergency message to a subset of Access Points (APs) within the private network based on the one or more particular UEs determined.

2. The method of claim 1, wherein private network operates a Citizens Broadband Radio System (CBRS) network architecture and the location component comprises an Evolved Serving Mobile Location Center (E-SMLC) of an MNO.

3. The method of claim 1, wherein the location component is located in the private network.

4. The method of claim 1, wherein determining comprises providing location information in response to requests made in accordance with Location Positioning Protocol (LPP).

5. The method of claim 4, wherein providing the location information includes LPP messaging, the LPP messaging being communicated on a secure tunnel that allows contents of communications to only be accessible to the UE and the network location component.

6. The method of claim 1, wherein determining includes requesting an identifier of one or more particular UEs, and wherein the method further comprises sending a response to the request, the response including information related to APs with local Tracking Area Identifiers (TAIs) and local AP identifiers.

7. The method of claim 6, wherein the information related to the APs includes AP identifiers, the AP identifiers not being unique for all Public Land Mobile Networks (PLMNs).

8. The method of claim 1, wherein determining includes providing a mapping between a private network AP identifier and a local Mobile Network Operators (MNO) AP-identifier that is unique within an MNO network.

9. The method of claim 8, the mapping being provided by a public Neutral Host Identifier Mapping System (NIMS) to local MNOs.

10. The method of claim 9, wherein the particular LCS client is a Public Safety Answering Point (PSAP).

11. The method of claim 10, further comprising the PSAP sending a request for the UE to provide information regarding a location of the UE in coordination with an Evolved Serving Mobile Location Center (E-SMLC) within the MNO network.

12. The method of claim 1, further comprising:
a) receiving at an enterprise network, an emergency call from the UE, and
b) routing, by the enterprise network, the emergency call, based on a Location Service (LCS) client.

13. The method of claim 1, the determining comprising:
a) sending a request for information about an identity of one or more components of a Mobile Network Operators (MNO) network; and
b) sending a response to the request, the response having the information about the identity of the one or more components of the MNO network.

14. The method of claim 1, further comprising:
a) storing an IMD in association with a MOCN gateway; and
b) mapping, by the MOCN gateway, a PCNN Cell-ID and a PCNN TAI with a notification area.

15. The method of claim 1, further comprising:
a) receiving an emergency message at the private network, the emergency message including a notification area;
b) matching, by the private network, cell sites with the notification area; and
c) broadcasting, by the private network, to the cell sites.

16. The method of claim 15, further comprising:
a) receiving a first emergency message from a first Mobile Network Operators (MNO) and a second emergency message from a second MNO, the second emergency message being a duplicate of the first emergency message;
b) determining that the second emergency message is the duplicate of the first emergency message; and
c) removing the second emergency message.

17. The method of claim 1, further comprising:
a) establishing a roaming connection between the enterprise network and a Mobile Network Operators (MNO) network core; and
b) transferring authentication data between the enterprise network and the MNO network core.

18. The method of claim 1, further comprising:
a) receiving at an enterprise MME measurement information from the UE; and
b) mapping an enterprise Cell-ID to a Mobile Network Operators (MNO) Cell-ID before forwarding measurement information to an MNO network.

19. The method of claim 1, the UE placing an emergency call, via a Mobile Network Operators (MNO) macro network and Location Based Service (LBS) function of an MNO network core, to a Public Safety Answering Point (PSAP).

20. A network system comprising one or more network devices having:
a) one or more processor systems; and
b) one or more memory systems storing one more machine instructions, which when implemented, cause the one or more network devices to implement a method including at least:
i. determining, based on a location component, one or more particular UEs (User Equipment) that are communicating via a private network; and
ii. directing an emergency message to a subset of Access Points (APs) within the private network based on the one or more particular UEs determined.
